(19) United States
(12) Patent Application Publication
(10) Pub. No.: US 2013/0066077 A1
(43) Pub. Date: Mar. 14, 2013

(54) BINDING SYSTEMS

(71) Applicants: Nobuyoshi Joe Maeji, Wishart (AU); Liqun Yang, Mile Rocks (AU); Nevin John Abernethy, Redland Bay (AU); Barbara Tengaten Fontanelle, Tingalpa (AU); Olya Aaliyah Savvina, Brisbane (AU)

(72) Inventors: Nobuyoshi Joe Maeji, Wishart (AU); Liqun Yang, Mile Rocks (AU); Nevin John Abernethy, Redland Bay (AU); Barbara Tengaten Fontanelle, Tingalpa (AU); Olya Aaliyah Savvina, Brisbane (AU)

(73) Assignee: Bio-Layer Pty Ltd, Eight Mile Plains (AU)

(21) Appl. No.: 13/697,293

(22) PCT Filed: May 10, 2011
(86) PCT No.: PCT/AU2011/000537

§ 371 Date: Nov. 9, 2012

Related U.S. Application Data
(60) Provisional application No. 61/332,866, filed on May 10, 2010.

(51) Int. Cl. C07F 11/00

(52) U.S. Cl. 546/2; 556/57; 548/101; 556/9

(57) ABSTRACT

A method of adapting a synthetic substrate for immobilisation of a target molecule thereon.

### FIELD OF THE INVENTION

The invention relates to the adaptation of synthetic surfaces for the immobilisation of target molecules thereon.

### BACKGROUND OF THE INVENTION

There is a need for simple processes to bind biomolecules such as peptides, proteins, oligonucleotides, oligosaccharides to target substrates for various applications in drug discovery research and diagnostics. There are many approaches in the prior art such as those described in Hermanson, et. al., Bioconjugate Techniques: Academic Press, 1996, but the number of well-used methods are limited. One method is the use of poly-histidine tags that bind with metal ions such as nickel and cobalt. Immobilised metal ion affinity chromatography (IMAC) is a highly reliable purification procedure that has been applied to other applications such as protein refolding, biosensors, and plate based immunoassays (Ueda, E. K. M., Gout, P. W., and Morganti, L. J. Chromatography A, 988 (2003) 1-23). In IMAC, the metal ions are immobilised through metal chelating groups covalently attached to some solid support with some free coordination sites to which protein can bind through the poly-His tag. Subsequently, the bound protein can be released by competition with imidazole and other chelating agents.

While protein release is a necessary requirement of IMAC, it is not desirable that the target protein is prematurely released. The poly-histidine tags need to be incorporated into proteins to eliminate problems of random metal-protein binding, unpredictable binding strength and reproducibility problems. Even so, metal interaction with poly-histidine tags is an intrinsically low affinity interaction and most proteins with only one poly-histidine tag would dissociate from a metal complex substrate under application conditions such as those found in solid phase assays. Two poly-histidine tags are necessary for stable binding under such conditions (Nieba, L., Nieba-Axmann, S. E., Persson, A., Hamalainen, M., Edebratt, F., Hansson, A., Lidholm, J., Magnusson, K., Karlsson, A. F. and Pluckthun, A. Anal. Biochem., 252 (1997) 217-228).

Another approach to binding target molecules to synthetic surfaces or substrates uses metal ions to form co-ordination complexes between target molecules and substrate, thereby linking target molecules to substrate without the need for prior modification of the target such as the addition of the above described poly-histidine tags. See in particular PCT/AU2005/00966 (published as WO 2006/002472).

There is a continuing need for synthetic substrates having new or improved capacity or functionality for binding to target molecules.

There is also a need for synthetic substrates having an improved binding affinity for a target molecule.

There is also a need for synthetic substrates that minimises any conformational damage to the target molecule.

There is also a need for synthetic substrates that are adapted to provide improved orientation of a target molecule.

There is also a need for synthetic substrates that are adapted to bind a target molecule and that have a relatively long shelf life in their activated state i.e. substrates that can be stored for, a greater time without significant loss of capacity for binding to a target molecule when later used to bind to a target molecule.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

### SUMMARY OF THE INVENTION

The invention seeks to address at least one of the above mentioned problems or limitations, or to address at least one of the above mentioned needs, and in one embodiment provides a method of adapting a synthetic substrate for immobilisation of a target molecule thereon. The method includes the following steps:

providing a synthetic substrate;

providing metal ions for binding with the substrate, wherein the metal ions are not complexed with a target molecule;

contacting the metal ions with the substrate in the absence of a target molecule thereby forming a co-ordination complex in which the substrate is bound to co-ordination sites of the metal ions;

forming oligomeric metal complexes from the metal ions in the presence of the substrate so that substantially all of the metal ions in the co-ordination complex with the substrate are in the form of oligomeric metal complexes;

thereby adapting the substrate for immobilisation of a target molecule thereon.

In another embodiment there is provided a method of adapting a synthetic substrate for immobilisation of a target molecule thereon. The method includes the following steps:

providing metal ions for binding with a substrate, wherein the metal ions are not complexed with a target molecule;

forming oligomeric metal complexes from the metal ions in the absence of the substrate so that substantially all of the metal ions are in the form of oligomeric metal complexes;

contacting the oligomeric metal complexes with the substrate in the absence of a target molecule thereby forming a co-ordination complex in which the substrate is bound to co-ordination sites of the metal ions of the oligomeric metal complexes;

thereby adapting the substrate for immobilisation of a target molecule thereon.

In certain embodiments there is provided a method of immobilising a target molecule on a synthetic substrate including:

providing a synthetic substrate and a target molecule to be immobilised thereon;

providing metal ions capable of binding with the substrate and the target molecule, wherein substantially all of the metal ions are provided in the form of oligomeric metal complexes;

contacting the oligomeric metal complexes with the target molecule and the substrate, thereby forming a co-ordination complex in which the substrate and the target molecule are bound to co-ordination sites of the metal ions of the oligomeric metal complexes, and in which the oligomeric metal complexes are arranged to link the target molecule with the substrate;

thereby immobilising the target molecule on the substrate.

In other embodiments there is provided a method of adapting a synthetic substrate for immobilisation of a target molecule thereon including:

providing a synthetic substrate for immobilisation of a target molecule thereon;

providing metal ions capable of binding with the substrate and the target molecule, wherein substantially all of the metal ions are provided in the form of oligomeric metal complexes;

contacting the oligomeric metal complexes with the substrate, thereby forming a co-ordination complex in which the substrate is bound to co-ordination sites of the metal ions of the oligomeric metal complexes;

thereby adapting said substrate for immobilisation of a target molecule thereon.

The two or more metal ions substantially in the form of an oligomeric metal complex may be screened/selected to provide a stable binding interaction or link between the target molecule and the substrate. By this is meant that the target molecule is immobilised on the substrate through coordination with two or more metal ions substantially all in the form of oligomeric metal complexes. The mechanism that is believed to operate is explained in more detail below.

By the term ‘substantially all in the form of oligomeric metal complexes’ is meant that the predominant proportion of the metal ions are in the form of oligomeric metal complexes (for example dimers, trimers, tetramers, etc), as opposed to monomeric metal complexes. For example, preferably than 75%, preferably more than 80%, preferably more than 85%, preferably more than 90%, preferably more than 95%, preferably more than 98 or 99% of metal ions in the co-ordination complex with the substrate are in the form of oligomeric metal complexes. The % amount of monomers or oligomers in a composition can be determined according to capillary electrophoresis methods described herein, and other methods known to the skilled worker.

A composition of metal ions wherein substantially all metal ions are in the form of oligomeric metal complexes can be obtained by fractionating a sample of metal complexes including monomeric and oligomeric complexes and recovering oligomeric complexes. It will be appreciated that in some embodiments, fractionation may be imperfect in which case there may be some residual monomeric metal complexes recovered with the oligomeric metal complexes.

In other embodiments, the composition may be produced in conditions that favour the production of oligomeric metal complexes over monomeric metal complexes, in which case the composition includes metal ions, wherein substantially all metal ions are provided in the form of oligomeric metal complexes.

In certain embodiments, the composition contains metal ions in the form of both monomeric and oligomeric metal complexes which when applied to the substrate under specific conditions may allow the complexes to compete for the available chelation sites on the substrate such that monomeric metal complexes are in effect out-competed for the limited chelating sites on the substrate.

In one embodiment there is provided a method of immobilising a target molecule on a synthetic substrate including:

providing a synthetic substrate and a target molecule to be immobilised thereon;

providing metal ions capable of binding with the substrate and the target molecule, the metal ions being in the form of oligomeric metal complexes and monomeric metal complexes;

contacting the metal complexes with the target molecule and the substrate in conditions in which the oligomeric metal complexes preferentially bind with the target molecule and the substrate, thereby forming a co-ordination complex in which the substrate and the target molecule are bound to co-ordination sites of the metal ions of the oligomeric metal complexes, and in which the oligomeric metal complexes are arranged to link the target molecule with the substrate;

thereby immobilising the target molecule on the substrate.

In further embodiments the method employs a composition of oligomeric metal complexes, or substrate coated with same, the composition being characterised in that it does not substantially include monomeric metal complexes.

The oligomeric metal complexes may include more than one type of metal ion, or these complexes may consist of a single type of elemental metal ion.

The oligomeric metal complexes may include the same number of metal ions. Alternatively, a composition of oligomeric metal complexes for use in conjugating or immobilising a target molecule on a substrate may include complexes having different numbers of metal ions. For example, a composition may have complexes that include 2, 3, 4, 5, 6, and more metal ions.

The oligomeric metal complexes may have the same conformation, geometry or structure. In other embodiments, a composition of metal ions for immobilising a target on a substrate may contain oligomeric metal complexes with differing conformations, geometries or structures. For example some may be linear, others branched, others clustered etc.

The present invention also resides in the synthesis and selection of oligomeric metal complexes (metal dimers, trimers, tetramers, etc) that have differential binding characteristics with respect to a target molecule and providing specific metal oligomers in such a manner that the binding outcome with respect to the target molecule can be further manipulated. The result is that the oligomeric metal complexes may achieve higher binding affinity, and possibly varying levels of selectivity, with respect to the target molecule through improved binding effect of the oligomeric metal complex. Similarly, by choosing specific mixtures of different oligomeric metal complexes in different ratios, further binding characteristics and selectivities maybe possible, with respect to the target molecule and substrate.

Herein the term “substrate” is used generically to denote some species to which it is desired to bind a particular target molecule. A “synthetic substrate” is generally a non biological substrate, i.e. it is not a cell or cell fragment. The “substrate” may be a conventional solid phase material that is a suitable platform for immobilising the target molecule of interest. Generally the substrate used will be a synthetic substrate of a format commonly used in pre-existing solid phase applications. For example, the substrate may include silica/glass, gold and other metals, or various plastic/polymer materials examples including poly(vinylalcohol) surface or methacrylate surfaces. The substrate may take any form. In biological applications the substrate will usually be in the form of micron or nanometer sized beads, membranes, multi-well plates, slides, capillary columns, cartridges or other formats. The surface of the substrate may already contain carboxylic acids, amides, amines, hydroxyl, aldehyde or other electron donating groups, or modified to present low levels of electron donating groups on its surface. As will be described, the surface characteristics of the substrate may not have optimal metal chelation ligands but through selection of specific oligomeric metal complexes or specific combinations thereof, it is possible to achieve efficacy or optimisation of the method described herein.

In embodiments of the present invention the term “substrate” is intended to embrace such things as detectable labels and other molecular species. The term “label” is used in the conventional sense to mean any species that is detectable and that may therefore be used to identify another molecule when attached thereto. The exact form of the label is not especially critical provided that the underlying principles of the present invention are applied. By way of example, the label may be a radioactive label, an enzyme, a specific binding pair component (e.g. avidin, streptavidin), a colorimetric marker or dye (e.g. UV, VIS or infra red dye), a fluorescent marker, chemiluminescent marker, an antibody, protein A, protein G, etc. The present invention may have particular utility in the field of diagnostic assays and in principle any label conventionally used to provide increased signal detection in that context may be employed. In this context the term is intended to denote the active (detectable) label species per se or an active label species bound to a coordination ligand that enables the active label to be bound to the metal complex used in accordance with the present invention. Depending upon the nature of the active label species, it may be necessary to screen and select specific oligomeric metal complexes or specific combinations thereof, to achieve the requisite association of active label species and metal of the metal complex.

The label may bind one or more oligomeric metal complexes and the oligomeric metal complex may bind one or more labels. In one embodiment of the invention the label may be polymeric in character comprising multiple active label species and it has the ability to bind (chelate) more than one molecule of oligomeric metal complex.

Herein the term “label” also embraces (pre-label) molecules, such as inorganic, organic or biomolecules (e.g. synthetic peptide or oligonucleotides) that do not have the capability to function as an active label as such but that may be further reacted or functionalised to result in detection of the pre-labelled target molecule. In this case this further reaction/functionalisation takes place without disruption of the binding (coordinate) interactions originally responsible for binding of the pre-label molecule and target molecule to the metal ion of the oligomeric metal complex. It will be appreciated that here the function of the metal complex is to act as a cross-linking agent between the target molecule and the pre-label molecule. As explained above, the pre-label molecule may need to be bound to a suitable coordinate ligand in order to effect binding through the metal complex.

In the following and unless context otherwise requires, for ease of reference the term “label” and variations thereof, such as “labelling”, will be used to embrace the embodiment described where the label is a pre-label and the effect of the invention is to facilitate cross-linking of the target molecule to the pre-label. Unless otherwise stated, in the context of the present invention, the term “target molecule” refers to any molecule that it is desired to label.

Unless otherwise stated, in the context of the present invention the term “target molecule” refers to a molecule that it is desired to immobilise on the substrate. In an embodiment of the present invention the target molecule is a biological molecule. The invention has particular applicability in relation to antibodies as the target molecule. This said the term target molecule may embrace any molecule that it is desired to immobilise on a substrate surface. For example, the target molecule may be a protein, such as an antibody, streptavidin, Protein A or Protein G.

Herein the term “oligomeric metal complex” refers to a metal complex species comprising two or more monomeric species joined together. The monomeric metal complex is the metal species formed when a metal ion in solution forms coordinate covalent bonds (also called dative covalent bonds) with electron donor ligands also present in solution. Such ligands will be called herein coordination ligands, metal ligands or simply, ligands. For example, in aqueous solution, chromium (III) may exist as an octahedral complex with six coordinate water molecules arranged around a central chromium ion. The nature of the monomeric metal complex formed for any given metal will depend upon the ligands in solution as well as the ability of the ligands to form suitably stable associations with the metal ion. The ligands may be mono-, bi- or poly-dentate depending upon their structure and ability to interact with the metal ion thereby forming a complex. Hydrates and/or anions are ligands (also called counter ions) that will invariably be part of the structure of the metal complex in solution.

The oligomeric metal complex comprises at least two of these monomeric metal complexes bound together, through one or more bridging interactions of a ligand. Larger oligomeric complexes can be formed by more ligands bridging more metal species to form clusters comprising many monomeric metal species. The monomeric metal complexes may be bound together to form oligomeric metal complexes having any conformation, geometry or structure. For example, the oligomeric metal complexes may have a linear, branched or cluster geometry or conformation. For example, FIG. 1 depicts three oligomeric complexes based on chromium. In this particular case, different pH conditions can result in bonding of individual monomeric chromium complexes, i.e. [Cr(H₂O)₆]³⁺, through ligands thereof, resulting in the formation of dimer, trimer and tetramer and larger oligomeric metal complexes. In one embodiment, the chromium based oligomeric metal complexes are hydrolytic oligomeric metal complexes. In another embodiment, chromium oligomeric metal complexes are formed through other bridging ligands between two or more individual metal ions. In another embodiment, different methods of bridging metal complex can be used in combination. Similarly, other metal complexes form oligomeric species, and different populations of oligomers are possible according to their specific method of formation. As well, addition of other ligands or combinations of ligands may result in more complex oligomeric metal complexes according to their specific method of formation. Hereafter unless otherwise specified the terms “metal complex” and “oligomeric metal complex” are used interchangeably. The structure of the oligomeric metal complexes is likely to impart different binding characteristics compared with the constituent monomeric form metal complexes as well as between the different oligomeric species.

Further, as oligomeric metal complexes have greater 3-dimensional complexity this provides greater flexibility of design than monomeric metal complexes. The present invention resides in selecting the most suitable oligomeric metal complex or mixtures thereof in order to achieve the desired binding interactions between target molecules and substrates that may not have appropriately strong chelation species for monomeric metal complexes. With this in mind the present invention is believed to have applicability to a range of different oligomeric metal complexes in terms of type of metal and oligomeric forms, and variation of these metal complexes represent a point of diversity that allows greater flexibility of practice of the present invention.

The mechanism, by which the metal complex facilitates binding of the target molecule, or rather a region of the target molecule, is believed to involve displacement by the target molecule of one or more ligands associated with the oligomeric metal complexes. For this to occur the target molecule must be able to form preferential associations with the metal ion of the metal complex when compared to one or more existing coordination ligands that are already present in association with the metal ion prior to interaction with the target molecule. It is possible in accordance with an embodiment of the invention to manipulate the binding characteristics of the metal ion with respect to the target molecule in order to achieve the desired binding interaction. Thus, in an embodiment of the invention one or more ligands associated with the metal ion are selected in order to control binding of the target molecule as required.

The oligomeric metal complexes may facilitate binding to the substrate by a similar ligand displacement mechanism as described above in connection with the target molecule, and the binding characteristics of the metal ion with respect to the substrate may also be manipulated as necessary.

Given the mechanism proposed, it will be appreciated that the species formed when a metal ion binds a target molecule could be regarded as being a metal complex since when bound the target molecule is a coordination ligand associated with the metal ion. The same could be said for the species formed when a metal ion binds to a substrate. However, to avoid confusion, unless otherwise stated or evident, the term “metal complex” will be used herein to refer to the oligomeric metal complex and associated coordinate ligands before any such binding events have taken place.

Herein, unless otherwise stated, the terms coordinate and bind, and coordination and binding interaction, are used interchangeably. As discussed, the use of oligomeric metal complexes imparts greater binding stability due to multiple binding interactions between the oligomeric metal complex and the substrate or target molecule. Depending on the complex structure (number of metal ions and their individual intrinsic binding affinity to some ligand) and the conditions of use, the strength of the coordinate bonds are tunable from essentially non-reversible covalent bonds to weak binding interactions.

The method of the present invention is likely to have particular applicability in solid-phase assays where it is desired to immobilise one or more target molecules on a solid substrate or to label target molecules with some detectable “tag” for identification purposes (in so-called capture assays). The invention may also have utility in affinity chromatography, 2D gel electrophoresis, surface plasmon resonance, both in vitro and in vivo imaging, delivery of therapeutic materials or processes and any other applications where a target molecule is known to be useful when bound to a substrate. The invention extends to the application of the method in any of these practical contexts.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1. Structure of hydrolytic chromium oligomers.

FIG. 2. The binding capacity of goat anti-mouse (GAM) polyclonal antibody to capture mouse monoclonal antibody-fluorescein changes depending on whether a monomeric or oligomeric chromium ions were used to bind the substrate to the GAM antibody.

FIG. 3. Ademtech beads treated with 100 mM chromium perchlorate/ethylene diamine complexes at pH 3 having approx. 30% monomeric component shows aggregation/clumping with loss of Brownian motion.

FIG. 4. Ademtech beads treated with 10 mM chromium perchlorate/ethylene diamine complexes at pH 3 having approx. 30% monomeric component shows aggregation/clumping with loss of Brownian motion.

FIG. 5. Ademtech beads treated with 100 mM chromium perchlorate/ethylene diamine complexes at pH 4 having approx. 10% monomeric component shows aggregation/Clumping with loss of Brownian motion.

FIG. 6. Ademtech beads treated with 10 mM chromium perchlorate/ethylene diamine complexes at pH 4 having approx. 10% monomeric component shows no aggregation/clumping and maintains full Brownian motion comparable with un-modified beads.

FIG. 7. Although aggregation and Brownian motion changes with different treatment of beads (FIGS. 3 to 6), in this example, the binding capacity of goat anti-mouse (GAM) polyclonal antibody to capture mouse monoclonal antibody-HRP is similar.

FIG. 8. The binding capacity of goat anti-mouse (GAM) polyclonal antibody to capture mouse monoclonal antibody-fluorescein changes with the different chromium oligomeric mixtures (designated Type X, Y and Z, respectively) used to bind the substrate to GAM antibody.

FIG. 9. The binding capacity of mouse monoclonal antibody to capture goat anti-mouse (GAM) polyclonal antibody-fluorescein changes with the different chromium oligomeric mixtures (designated Type X, Y and Z, respectively) used to bind the substrate to Mouse antibody.

FIG. 10. The use of different ligands at the same molar concentration to form different oligomeric complexes changes the binding capacity of goat anti-mouse (GAM) polyclonal antibody to capture mouse monoclonal antibody-fluorescein.

FIG. 11. Over 2 fold increase in binding capacity of goat anti-mouse (GAM) polyclonal antibody to capture mouse monoclonal antibody-fluorescein can be achieved by pre-treatment of metal-substrate complexes prior to binding target molecule. In this example, by changing pH (less than 2 pH units) after formation of oligomeric metal-substrates, different outcomes are archived.

FIG. 12. Oligomeric metal complexes are effective in binding antibodies on silica surfaces whether the surface has either —OH or —COOH functionalities. The example shows comparable performance with polymeric beads using one particular formulation of oligomeric metal complexes.

FIG. 13. Using the same oligomeric metal-substrate complex as in FIG. 12, binding streptavidin show that its capacity to capture biotinylated molecules is 2× superior with the Silica-COOH surface.

FIG. 14. Different coupling buffers used to couple oligomeric metal bead complexes changes the binding capacity of goat anti-mouse (GAM) polyclonal antibody to capture mouse monoclonal antibody-fluorescein.

FIG. 15. Activated chromium oligomer bead complexes are stable showing the same performance when goat anti-mouse (GAM) antibody was coupled immediately or after 180 day storage. Even storage in PBS which is supposed to destroy binding gives better performance of GAM to capture mouse monoclonal antibody-fluorescein.

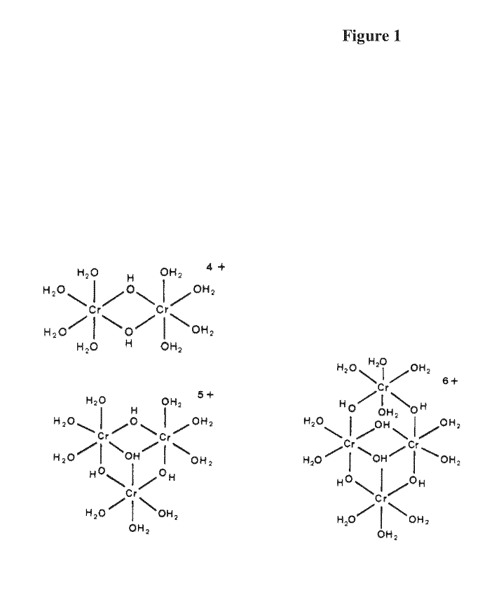

### DETAILED DESCRIPTION OF THE EMBODIMENTS

Reference will now be made in detail to certain embodiments of the invention. While the invention will be described in conjunction with the embodiments, it will be understood that the intention is not to limit the invention to those embodiments. On the contrary, the invention is intended to cover all alternatives, modifications, and equivalents, which may be included within the scope of the present invention as defined by the claims.

One skilled in the art will recognize many methods and materials similar or equivalent to those described herein, which could be used in the practice of the present invention. The present invention is in no way limited to the methods and materials described.

It will be understood that the invention disclosed and defined in this specification extends to all alternative combinations of two or more of the individual features mentioned or evident from the text or drawings. All of these different combinations constitute various alternative aspects of the invention.

In work leading to the invention described herein, the inventor found that certain manipulations of metal complex compositions, such as those described in PCT/AU2005/00966 (published as WO 2006/002472) enabled the formation of synthetic substrates having surfaces with improved binding affinity for target molecule, or improved capacity for orientation of bound target molecule, or less damage to the functionality of target molecule and most importantly, increased robustness, reproducibility, and stability for improved shelf life of the modified substrate. Further investigation as to the nature of the compositions in manipulated and non manipulated form has revealed that in one embodiment, the key difference is the proportion of metal oligomers that are bound to the substrate. Specifically, as described in the Examples herein, the inventor has found that compositions and substrates prepared according to the methods of PCT/AU2005/00966 (published as WO 2006/002472) tend to have a lower content of oligomeric metal complexes (about 70% or less) and a higher content of monomeric metal complexes (up to about 30%). By contrast, the compositions and substrates disclosed herein have an oligomeric metal complex content greater than 70% and higher than 90% and a monomeric metal complex content of as little as 10% or less. With various experiments described herein, the inventor has shown that the key advantages of modified binding of target molecule and improved increased robustness, reproducibility, and stability of activated substrate (i.e. substrate that by the process of the method is adapted for binding target) can arise from the higher content of oligomeric metal complexes. This was unanticipated at the time of the invention.

In one embodiment, the invention is a method of adapting a synthetic substrate for immobilisation of a target molecule thereon. The method includes the following steps:

providing a synthetic substrate;

providing metal ions for binding with the substrate, wherein the metal ions are not complexed with a target molecule;

contacting the metal ions with the substrate in the absence of a target molecule thereby forming a co-ordination complex in which the substrate is bound to co-ordination sites of the metal ions;

forming oligomeric metal complexes from the metal ions in the presence of the substrate so that substantially all of the metal ions in the co-ordination complex with the substrate are in the form of oligomeric metal complexes;

thereby adapting the substrate for immobilisation of a target molecule thereon.

This embodiment generally relates to forming a coating or layer of metal complexes on the surface of a substrate, the coating or layer being characterised in that substantially all metal complexes in the coating or layer are provided in the form of oligomeric complexes. As discussed further herein, the product of this process may be referred to as an “activated substrate” in the sense that the substrate, in having oligomeric metal complexes arranged thereon is then able to bind to a target molecule for immobilisation of the target molecule thereon.

The inventor has found that generally the oligomeric metal complexes can be formed by providing conditions for forming electron donating groups for bridging or otherwise linking or bonding two or more metal ions. This can be done by providing a pH of about 3.3 to 11, preferably about 4 to 10, preferably about 4 to 8 or 4, 5, 6 or 7 to the composition formed from the contact of the metal complexes with the substrate. In PCT/AU2005/00966 (published as WO 2006/002472), pH conditions were generally below 3, and any adjustments were avoided by performing reactions in saline solutions.

The process steps of the method of the above described embodiment may be carried out as one single step. Importantly, it will be understood that the formation of the co-ordination complex with the substrate and metal ions and the oligomerisation of metal ions generally occurs simultaneously once the metal ions and substrate have been contacted with each other and the pH of the relevant composition has been adjusted to the above described ranges.

While not wanting to be bound by hypothesis, it is believed that in the above described embodiment the relatively higher pH ranges implemented form electron donating groups, for example on the substrate and also in a bridging ligand (described further below) that might be present with the metal ions, thereby assisting in oligomerisation and formation of the co-ordination complex between the substrate and oligomeric metal complexes.

The step of forming oligomeric metal complexes from the metal ions in the presence of the substrate so that substantially all of the metal ions in the co-ordination complex with the substrate are in the form of oligomeric metal complexes may be conducted in the absence of target molecule.

It will be understood that the metal ions can be made to form oligomeric metal complexes before contact with the substrate. In the circumstances, a composition is formed in which substantially all metal ions in the compositions are provided in the form of oligomeric metal complexes for contact with a substrate. Thus in another embodiment there is provided a method of adapting a synthetic substrate for immobilisation of a target molecule thereon. The method includes the following steps:

providing metal ions for binding with a substrate, wherein the metal ions are not complexed with a target molecule;

forming oligomeric metal complexes from the metal ions in the absence of the substrate so that substantially all of the metal ions are in the form of oligomeric metal complexes;

contacting the oligomeric metal complexes with the substrate in the absence of a target molecule thereby forming a co-ordination complex in which the substrate is bound to co-ordination sites of the metal ions of the oligomeric metal complexes;

thereby adapting the substrate for immobilisation of a target molecule thereon.

The step of forming oligomeric metal complexes from the metal ions in the absence of the substrate so that substantially all of the metal ions are in the form of oligomeric metal complexes may be conducted in the absence of target molecule.

In this embodiment, oligomers are preferentially formed from monomeric metal complexes by providing conditions for forming electron donating groups for bridging or linking two or more metal ions in the composition. This can be done by providing a pH of 3.3 to about 11, preferably about 4 to 10, preferably about 4 to 8 or 4, 5, 6 or 7 to the composition.

As described herein the relevant pH conditions can be provided by providing a salt, or bridging ligands. A “salt” is generally a compound which results from the replacement of one or more hydrogen atoms of an acid by metal atoms or electropositive radicals. In this context, examples of salts include NaOH, KOH or NH₄OH and other alkaline salts. Generally those preferred salts are those that will raise the pH of the metal complex/substrate composition, and particularly those that provide a counter ion capable of serving as a co-ordination ligand in the relevant co-ordination complex with substrate.

Turning to the relevant bridging ligands, these may be in the form of a compound, generally an organic compound, that contains one or more functional groups with electron donating potential, particularly at the pH ranges described above. These ligands may be described as “basic” or “acidic” ligands. The latter are in depronated form in the above described pH ranges. Examples of basic ligands are described herein and preferred ligands include those containing an amine or imine group, especially ethylenediamine.

Examples of metal ions useful in the above described embodiments are as described below.

In other embodiments the invention resides in forming and identifying oligomeric metal complexes and/or their mixtures that are capable of achieving a predetermined and desired binding interaction between a target substrate and a target molecule. In this respect the oligomeric metal complex may be regarded as being a form of cross-linking agent that facilitates binding of the target molecule to the target substrate. Through multi-component binding, the intention is to achieve a stable binding interaction involving the oligomeric metal complex, the targeted substrate and the target molecule under the conditions at which these species are exposed to one another. The binding interaction must also be stable under the conditions of practical application of the present invention, such as a diagnostic assay or the like.

It will be appreciated that the oligomeric metal complex useful in practice of the present invention is one that is capable of undergoing thermodynamically stable ligand displacement thereby forming a stable binding interaction (i.e. coordinate bond) with the substrate and with the target molecule under the conditions (such as pH, temperature; ionic strength, etc.) at which these species are exposed to each other and under the conditions associated with the practical application (e.g. an assay) in which the methodology of the invention is employed. This is achieved through multiple metal chelation within the oligomeric complex, that together in combination maintains the desired stability. In this respect the substrate-metal, metal-target molecule and target substrate-metal-target molecule binding interaction(s) is/are thermodynamically stable due to a sufficient number of metal binding interactions such that the desired interactions prevail over other possible (coordination ligand) binding interactions that the metal may otherwise undergo depending upon the prevailing practical conditions under which the binding interaction(s) occur. This means, for example, that the nature of the interaction(s) between the metal and the target substrate is such that the target molecule does not become disassociated from the target substrate-metal complex after binding thereto via the oligomeric metal complex and/or their mixtures.

In another embodiment, the oligomeric complex useful in the invention is one that forms a sufficiently strong interaction with target molecule but can be subsequently detached from the oligomeric complex on the substrate.

In one embodiment of the present invention, the oligomeric metal complexes include one or more binding ligands selected to determine the overall molecular weight distribution and size range of the final oligomeric metal complex, and hence changing the overall binding characteristics of the metal complex for the substrate and/or target molecule.

In a further embodiment of the invention the oligomeric metal complex and target substrate are bound to each other prior to exposure to the target molecule. In this embodiment, the addition of target molecule could be done immediately after formation of the oligomeric metal-substrate complex, or alternatively, be performed on oligomeric metal-substrate complexes stored for some period of time. Here the method of the invention involves forming an oligomeric metal-substrate complex that is both storable and active to bind target molecule on exposing a predetermined metal-target substrate complex to an analyte containing the target molecule. Selection of a suitable oligomeric metal complex(es) to form the metal-target substrate complex will depend upon a variety of factors. The mechanism by which the metal-target substrate complex binds to the target molecule, or rather to a region of the target molecule, is believed to involve displacement by the target molecule of one or more ligands associated with the oligomeric metal complex. For this to occur the target molecule must be able to form preferential associations with the metal ions of the metal-target substrate complex when compared to one or more existing coordinate ligands that are already in association with the metal complex prior to interaction with the target molecule. It is possible in accordance with an embodiment of the invention to manipulate the binding characteristics of the metal-target substrate complex with respect to both long term storage and to the target molecule in order to achieve the desired binding interaction with the target molecule.

Examples of metal ions that may be used include ions of transition metals such as scandium, titanium, vanadium, chromium, ruthenium, platinum, manganese, iron, cobalt, nickel, copper, molybdenum and zinc. Chromium, ruthenium, iron, cobalt, aluminium and rhodium are preferred.

The usefulness of metals in accordance with the invention may vary depending on the oxidation state of the metal. For example, chromium (III) may be useful in embodiments of the invention. One or more binding ligands may be included in the oligomeric metal complex to determine the overall molecular weight distribution and size range of the final oligomeric metal complex. Ligands containing electron donating species can be used to form oligomeric metal complexes. Simple ions such as OH⁻ or NH²⁻, to more complicated structures can be used as bridging ligands. Both basic and acidic ligands can be used Ligands containing one or more lone pairs of electrons can be amines, imines, carbonyls, ethers, esters, oximes, alcohols, thioethers amongst others. Other examples of basic ligands include pyridine, imidazole, benzimidazoe, histidine, or pyridine, most preferably ethylene diamine. Acidic ligand that can coordinate with metal complexes on losing a proton can be carboxylic acids, sulphonic acids, phosphoric acids, enolic, phenolic, thioenolic or thiophenolic groups, amongst others. Other examples of acidic ligands include iminodiacetic acid, nitrilotracetic acid, oxalic acid, or salicylic acid. Combinations of bridging ligands can also be used. For example, amine ligands may be selected from the group including, but not limited to, ammonia, ethylamine, ethylenediamine, diethylenetriamine, bis-aminopropylethylene diamine, etc. In such cases, both OH⁻ or NH₂— can act as bridging ligands. Such oligomeric metal complexes can be further manipulated by addition of other bridging ligands such as those containing carboxylic acids to form more complex structures. Any ligand able to bridge across 2 or more metal ions can be used to form oligomeric metal complexes and as a consequence, binding of the oligomeric metal complex to bind target substrate and/or target molecule is further affected.

The oligomeric metal complex may bind to the target substrate by mono-, bi- or poly-dentate ligands that already exist on the target substrate. Any electron donating groups can bind with oligomeric metal complexes. Both basic or acidic ligands can be used. Ligands containing one or more lone pairs of electrons can be amines, imines, carbonyls, ethers, esters, oximes, alcohols, thioethers amongst others. Acidic ligand that can coordinate with metal complexes on losing a proton can be carboxylic acids, sulphonic acids, phosphoric acids, enolic and phenolic groups, amongst others. While some such ligands are not known to form strong binding interactions with monomeric metal complexes, strong binding stability may be achieved through multiple interactions within the oligomeric metal complexes.

In one embodiment, the concentration of the metal ions for oligomerisation in the methods of the invention may be selected so that the product of the relevant method is non aggregated substrate, for example where the substrate is in the form of beads, non aggregated beads.

The counter ions included in the oligomeric metal complex may be selected from the group consisting of but not limited to chloride, acetate, bromide, phosphate, nitrate, perchlorate, alum and sulphate.

In another embodiment a monomeric metal ion complex bound to the substrate may be oligomerized (by suitable exposure thereto) to form an (oligomeric metal ion complex)-(target substrate) conjugate. The substrate is then cross-linked by exposing this conjugate to the target molecule, the metal ion moiety of the conjugate undergoing a binding interaction with the target molecule as a result of displacement of one or more coordinate ligands (still) associated with the metal ion when bound to the substrate. Similar selection criteria for the metal complex as described above will apply.

In another embodiment the oligomeric metal ion complex is bound to the target molecule (by suitable exposure thereto) to form a (metal ion)-(target molecule) conjugate. The target molecule is then cross-linked by exposing this conjugate to the substrate, the metal ion complex moiety of the conjugate undergoing a binding interaction with the target substrate as a result of displacement of one or more coordinate ligands (still) associated with the metal ion complex when bound to the target molecule. Similar selection criteria for the oligomeric metal complex as described above will apply.

With these cases, the reaction mixture may also contain buffers and/or preservatives, typically from the analyte to stabilise the target molecule. For the invention to work as intended it is important that any buffer or preservative, or rather ligands/ions from the buffer or preservative does not detrimentally interfere with binding interactions necessary to bind the target molecule to the substrate, by whatever order of binding events that occur. For any given system it may be necessary to manipulate the ligand chemistry in order to ensure that the desired interactions prevail over interactions that would otherwise compromise the required binding interactions.

Irrespective of the exact methodology employed it is important that the substrate and target molecule are able to interact with each other through the oligomeric metal complex in order to achieve the desired binding effect. In this respect the oligomeric metal complex functions as a molecular “glue”. Preferential binding of the substrate and target molecule through the oligomeric a metal complex will be largely determined by thermodynamic considerations based on the prevailing conditions under which the target substrate and target molecule are exposed to each other in the presence of the oligomeric metal complex. In the context of an assay this will obviously be dependent upon the conditions under which the assay is performed and on the characteristics of the analyte containing the target molecule(s).

In practice, identification of suitable oligomeric metal complex(es), including the number and type to be used in the present invention may be undertaken through a process of discovery using a library of different combinations of species. In accordance with this process the ability of a particular metal compound to form a oligomeric metal complex, the conditions under which different oligomeric populations are formed and the ability of the oligomeric metal complex to bind a particular substrate to a particular target molecule is assessed over a variety of different permutations based on the oligomeric metal compounds used, the substrate, the target molecule and the prevailing conditions. The affinity for the substrate to a target molecule by interaction through oligomeric metal complexes may be assessed in order to identify combinations of variables that yield desirable results. By proceeding in this way it is in fact possible to rank combinations of variables according to observed binding efficacy to a given target molecule. This discovery process affords great flexibility in approach. For example, it may be desired to produce an operative binding system based on a specific target molecule. Here, in the discovery process the target molecule is maintained constant throughout with other possible variants being manipulated in order to identify potentially useful combinations specific to that target molecule and label. It will be appreciated that this approach has extensive potential and scope without departing from the general concept underlying the invention, i.e. the use of oligomeric metal complex to achieve, binding of a substrate to a target molecule.

In one embodiment, the metal ion is a transition metal. Examples include rhodium, platinum, scandium, aluminium, titanium, vanadium, chromium, ruthenium, manganese, iron, cobalt, nickel, copper, molybdenum or zinc. It has been found that certain metal compounds result in complexes (in aqueous solution) that are generally useful as leads in the discovery process described. Various metals such as Fe(III), Co(III), Al(III), Cr(III) and Ru(IV) can exist in a distribution of smaller oligomeric species formed by β-hydroxo and μ-oxo bridges between the metal centres to give dimeric, trimeric, tetrameric and higher order oligomers but oligomeric metals are not just restricted to these metal ions, nor is oligomeric formation restricted only to μ-hydroxo and μ-oxo bridges. Chromium oligomers have been found to be especially suitable for practice of the present invention.

In another embodiment, other oligomerics species can be formed through, additions of other chelating ligands such as ammonia, ethylamine, ethylene diamine, etc; and/or acetic acids, succinic acids, etc, and the actual conditions of oligomer formation changes the population distribution of the various forms. The possible diversity of oligomeric complexes are greatly expanded and through multiple binding interactions, substrates and target molecules having low electron-donating potential are now able to form stable interactions for the practical application of the invention. The ability to form and use diverse populations of metal oligomers have not been applied to improve the performance of applications requiring the binding of target molecules to target substrates. As a consequence there are no applications where different populations of oligomeric metal complexes are screened to test the performance of the target molecule once bound to some substrate for use in chromatography, in solid phase assays, in diagnostic imaging, in therapeutic drug delivery, and other applications of interest. The use of different populations of chromium oligomers through additions of different concentrations of base and/or potential chelating ligands have been found to give different outcomes in immunoassays. This observation is based on experiments using particular target molecules.

In an embodiment of the invention the nature of the ligands in forming oligomeric metal complexes helps determine make up the metal complex and “available” for displacement by a target molecule may also be controlled in order to manipulate binding as required. For example, where it is has been found that a given functional group or region of the target molecule exhibits a particular binding affinity to a particular metal complex or metal-label complex, it may be possible to enhance (or weaken) the binding affinity by inclusion in the complex of one or more ligands that are more easily displaced when interaction with the target molecule takes place. In this and similar ways it may be possible to provide selectivity to some functional group or region of a given target molecule by varying the type of coordinate ligands present in the complex being used to bind the target molecule.

The present invention also provides a composition for immobilising a target molecule on a substrate including:
a metal ion haying co-ordination sites capable of binding with a substrate and a target molecule, wherein substantially all of the metal ions are in the form of oligomeric metal complexes.

The present invention also provides a synthetic substrate for detection of an analyte in a sample, including:
metal ions having co-ordination sites bound to the substrate and the target molecule, wherein substantially all of the metal ions are provided in the form of oligomeric metal complexes.

The present invention also provides a method for determining whether a sample contains an analyte including,
providing a substrate as described above and having a target molecule immobilised thereon;
contacting the substrate with a sample in which the presence or absence of the analyte is to be determined in conditions for the target molecule to bind the analyte;
determining whether the target molecule has bound the analyte; thereby determining whether a sample contains an analyte.

The present invention also provides a kit for immobilising a target molecule on a substrate including:
metal ions having co-ordination sites capable of binding with a substrate and a target molecule, wherein substantially all of the metal ions are in the form of oligomeric metal complexes.

It will be understood that the invention disclosed and defined in this specification extends to all alternative combinations of two or more of the individual features mentioned or evident from the text or drawings. All of these different combinations constitute various alternative aspects of the invention.

### EXAMPLES

Embodiments of the present invention are illustrated in the following non-limiting examples.

### Example 1

### Binding of Substrates to Monomeric Chromium Complexes, or to Oligomeric Chromium Complexes

Binding target molecule onto bead substrates using monomeric chromium ions was compared to one example of an oligomeric chromium complex containing 0% monomeric form.

a. Chromium Monomer Solution

In brief, chromium perchlorate hexahydrate (2.3 g) was dissolved into 50 mL of purified water and mixed thoroughly until all solid dissolves. Using a Beckman Coulter ProteomeLab PA800 Capillary Electrophoresis (CE) instrument, and their recommended protocols, this solution was found to be approx. 99% monomer with a pH of 2.1

Chromium Oliogomer Solution

Chromium Perchlorate with Bis(3-aminopropyl)diethylamine.

In brief, chromium perchlorate hexahydrate (2.3 g) was dissolved into 25 mL of purified water and mixed thoroughly until all solid dissolves. Similarly, 545 ul of bis(3-aminopropyl)diethylamine solution was added to 25 mL of purified water. The solutions were combined and stirred for 2 days at room temperature.

Known concentrations of freshly prepared aqueous chromium perchlorate hexahydrate solutions were run on a CE to obtain calculated peak areas of the monomeric chromium species to give linear correlation of >0.9999. Using this standard curve, analysis of Chromium Perchlorate/Bis(3-aminopropyl)diethylamine complex showed no detectable monomeric species by CE analysis. The solution had a pH of 4.3.

b. Addition of Chromium Solutions to Magnetic Beads (Bangs).

ProMag carboxyl-terminated magnetic beads (Cat. No. PMC3N/9080) were supplied from Bangs, Ind., USA. To prepare the beads, allow them to reach room temperature and vortex the beads for 30 sec, then sonicate for another 60 sec. Dispense 2×50 uL of bead concentrate into a 2×1.7 mL microtube. Place tubes on a magnetic rack for 1 min and carefully remove and discard the supernatant from the bead pellet. To the bead pellet, add to each tube 50 uL of the respective chromium solutions. Leave for 1 hr at RT with rotation.

c. Coupling of Goat Anti-Mouse Polyclonal Antibody to Chromium Ligated Bead Surface

Take the chromium activated Bangs ProMag beads from the rotor and vortex suspension for 30 secs. Place tubes on a magnetic rack for 1 min and carefully remove and discard the supernatant from the bead pellet. Add to each tube, 50 ul of 50 mM MES buffer (pH 5.2). Repeat vortexing, removal of supernatant and MES addition two (2) more times. After removal of supernatant, add 50 ul of 1.0 mg/ml goat anti-mouse polyclonal antibody, Fc specific (Lampire Biological, Cat. No. 7455527, USA) in 50 mM MES to the bead pellet. Vortex bead solution for 30 secs. Incubate the tubes with rotation for 1 hr at RT.

After vortexing the suspension for 30 secs, place tubes on a magnetic rack for 0.1 min and carefully remove and discard the supernatant from the bead pellet. To the bead pellet, add 50 uL of 150 mM Saline with 0.025% Proclin 300 solution to the tube. Vortex, and repeat wash in saline solution 2 more times.

d. Performing Antibody Loading Assay.

The antibody loading assay on magnetic beads was performed according to the procedure below. In brief, the materials and methods are as described.

Assay Components:

Antibody coupled beads.

Detection Antibody: Mouse-IgG-FITC (2 mgs/ml, Jackson, USA)
Wash Buffer: 10 mM PBS, pH 7.4 containing 0.05% Tween 20
Assay Buffer: 10 mM PBS, pH 7.4 containing 1% BSA, 0.05% Tween 20
Microplate: 96-well Millipore 0.42 um filter plate (Millipore, USA)

Assay Protocols:

Dilute 2.5 ul of each bead sample in 45 ul of Assay Buffer. After vortexing for at least 30 secs, remove 40 ul of suspension and dilute again in 760 ul of Assay Buffer. Dilute mouse IgG-FITC detection antibodies in Assay Buffer to working concentration of 10 ug/ml. After vortexing diluted bead suspension for at least 30 secs, add 100 ul of antibody coated beads to the wells. Remove the beads solution from wells using filter vaccuum apparatus. After adding 50 ul of detection antibodies to the appropriate wells, incubate for 60 mins at room temperature on the plate shaker in the dark. Remove the detection antibody solution form wells using filter vacuum apparatus. Add 200 ul of wash buffer to each well of the plate and place the plate on the plate shaker for 30 seconds. Remove 200 ul of supernatant from the wells. Adding 200 ul of Wash Buffer to each well, read beads on FACS Canto II (BD Biosciences, USA).

e. Example of Results.

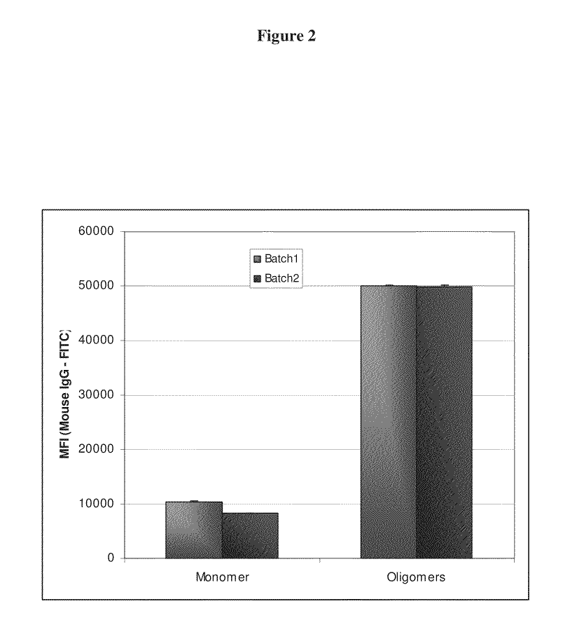

Comparison of the goat anti-mouse antibody bound to magnetic beads using monomeric chromium ions vs oligomeric chromium ions showed very different capacity to bind mouse antibody. Under the same conditions, the oligomeric formulation gave five (5) times the binding of mouse antibody (see FIG. 2). The amine additive may initiate oligomerisation by 2 possible modes of action. Specifically, there are 4 amino groups in Bis(3-aminopropyl)diethylamine complex that may allow potential bridging between metal ions. Further, the pH at 4.3 may allow formation of hydrolytic links between metal ions.

### Example 2

### Comparison of different purified chromium oligomers

a. Fractionation of Chromium Di- and Tri-mers

Chromium di-mer, tri-mer and other oligomers were fractionated according to procedures described in Spiccia, L., Marty, W. and Giovanoli, R. Hydrolytic Trimer of Chromium(II1). Synthesis through Chromite Cleavage and Use in the Preparation of the “Active” Trimer Hydroxide, Inorganic Chemistry, 1988, 27, 2660-2666, and Stunzi, H. and Marty, W. Early Stages of the Hydrolysis of Chromium(II1) in Aqueous Solution. 1. Characterization of a Tetrameric Species, Inorganic Chemistry, 1983, 22, 2145-2150.

In brief, a solution of Cr³⁺ (5 mL, 0.5 M) in acid (ca. 0.66 M HClO₄) was transferred into a volumetric flask (50 mL) and NaOH (10 mL, 2 M) added while stirring vigorously and continuously. The resultant green solution was immediately acidified by adding HClO₄ (35 mL, 2 M). This solution was left at 25° C. for 24 hours. An aliquot (3 mL) was then taken, diluted to 90 mL with water and 10 mL of 0.7M HClO₄ were added. The resulting solution was adsorbed onto SP Sephadex cation-exchange columns (1×5 cm). Elution started by adding 1 mL of 0.5 M NaC10, +0.01M HCIO. When the level of supernatant eluent was down to 2 mm, another 1 mL of this 0.5 M NaC104 was added, then 1 mL of 1 M NaClO₄, +0.01M HClO₄, and again a further 6 mL portion of this last solution. By this time, the band of the blue-purple monomer had moved down significantly and also the blue-green di-mer had separated from the green polymers at the top of the resin. Elution was continued with 1 and then 6 mL of 2 M NaClO₄+0.02 M HCIO₄, and then 1 mL of 4 M NaClO₄, +0.04 M HCIO₄. In the meantime, monomer and di-mer had completely eluted and the green band of the trimer had reached the bottom of the column. Further elution with this 4M NaClO₄, solution gave the tri-mer.

Solutions from columns were analysed by UV/Vis and found to contain different UV/Vis active species of different but similar concentrations (see Table 1).

b. Addition of Chromium Mono-, Di-, and Tri-Mers to Luminex Beads.

To prepare the beads, allow them to reach room temperature and vortex the beads for 20 sec, then sonicate for another 20 sec. The beads must be suspended as single mono-dispersed particles. If any aggregate beads are observed, repeat the vortexing and sonication until aggregates are not observed. Dispense 100 uL of bead concentrate into a 1.7 mL microtube. Centrifuge the beads solution at 14,000 rpm for 3 min after which remove the tube and gently flick it to dislodge beads on the side of the tube, then centrifuge for 5 more min. Carefully remove and discard the supernatant from the bead pellet. To the bead pellet, add 100 uL of chromium oligomers solutions eluted from the columns. After addition, sonication and vortexing, stand the suspension for 60 min with occasional mixing. After this time wash the beads three times in deionised water.

c. Coupling of TSH Capture Antibody to Chromium Ligated Bead Surface

A concentration of 100 ug/mL of the TSH capture antibody (OEM Concepts antibody, clone #057-11003) in 50 mM acetate buffer (pH5.0) was used. To 250 uL of chromium coated beads spun down to a plug with no supernatant was added 250 uL of the antibody solution. The solution was vortexed and sonicated, and left to stand for 1 hr with occasional vortexing. The solution was washed once with 150 mM saline. The antibody coupled beads were stored in saline containing 0.05% azide at 4° C. before running the assay.

d. Coupling of TSH Capture Antibody by Amide Coupling (Control)

Anti TSH monoclonal antibody (OEM Concepts antibody, clone #057-11003) were coupled to Luminex xMAP Microspheres using the recommended Luminex procedures. The beads were allowed to reach room temperature, vortex for 20 sec, then sonicated for another 20 sec. The beads must be suspended as single mono-dispersed particles. If any aggregate beads are observed, repeat the vortexing and sonication until aggregates are not observed. Dispense 100 uL of bead concentrate into a 1.7 mL microtube. Centrifuge the beads solution at 14,000 rpm for 3 min after which remove the tube and gently flick it to dislodge beads on the side of the tube, then centrifuge for 5 more min. Carefully remove and discard the supernatant from the bead pellet. Repeat washing procedure with 0.1M sodium phosphate buffer, pH 6.3.

For each 100 uL of bead concentrate (1.25×10⁶ beads) that has been spun down as described, add 50 uL of 50 mg/mL solutions of 1-ethyl-3-(3-dimethylaminopropyl) carbodiimide (EDC) and N-hydroxysulfosuccinimide (S-NHS) in 0.1M sodium phosphate buffer, pH 6.3 and leave to stand at room temperature in the dark for 20 mins with occasional vortexing. The beads were then washed twice with 200 uL of 0.05M 2-(N-morpholino)ethansulfonic acid (MES) buffer, pH 5.0.

After resuspending beads in 200 uL of MES buffer with sonication and vortexing, 75 uL of antibody (200 ug/mL in MES buffer) was added and left to incubated at room temperature on a gentle shaker for 2 hours. The beads are then washed with 2×200 uL 10 mM PBS with 0.05% Tween. Finally the beads are stored in 100 uL of 10 mM PBS with 1% BSA and 0.05% Azide (pH 7.4)

e. Performing TSH Assay

The TSH assay on multiplexed beads was performed according to the Luminex procedure. In brief, the materials and methods are as described.

Assay Components:

Antibody coupled beads: Add 10 uL of concentrate to 590 uL of Assay Buffer

Detection Antibody: Detection anti-TSH monoclonal antibody (Medix Biochemica antibody, clone #5403) was biotinylated using EZ-Link-Sulfo-NHS-LC-Biotin (Pierce). Working solution was 20 ug/mL in 10 mM PBS containing 1% BSA
TSH Standards were prepared in 10 mM PBS containing 1% BSA
Streptavidin-R-Phycoerythrin: 20 ug/mL in 10 mM PBS containing 1% BSA
Wash Buffer: 10 mM PBS containing 1% BSA
Assay Buffer: 10 mM PBS containing 4% BSA

Assay Protocols:

Pre-wet the filter plate by placing 100 uL of Wash Buffer into each well and applying vacuum sufficient to gently empty the wells. Add 20 uL of TSH Standard to the appropriate microtiter wells. Add Assay Buffer to zero (0 uIU/ml) wells. Add 10 uL of the diluted bead mixture to the appropriate microtiter wells. Shake the filer plate at room temperature at 500 rpm for 1 hr in the dark, then add 20 uL of the Anti-TSH Detection Antibody solution to the appropriate microtiter wells. Shake the filer plate at room temperature at 500 rpm for 30 min in the dark and then add 20 uL of the diluted Streptavidin-R-Phycoerythrin solution to the appropriate microtiter wells. Shake the filer plate at room temperature at 500 rpm for 15 min in the dark. Remove the solution from wells by applying vacuum sufficient to gently empty the wells. Add 100 uL of Wash Buffer into each well and apply vacuum sufficient to gently empty the wells. Repeat wash procedure, then add 100 uL of Wash Buffer to each well and shake for 60 sec. Load the plate into the Luminex XYP platform and read.

f. Example of Results.

As shown in Table 2, the outcome of the TSH assays is distinctly different when different chromium species are used to bind anti-TSH antibody to Luminex beads. The poorer signal with monomeric chromium ions suggest either poor binding of antibody or that the oligomeric species bind to different sites on the antibody so changing its binding capacity for TSH antigen.

### Example 3

### Increasing Oligomer Formation: Combination of Amine and Hydroxide Binding Ligands

a. Formation of Different Chromium Solutions.

Chromium Oligomer Solution (containing 30% monomer). In brief, chromium perchlorate hexahydrate (2.3 g) was dissolved into 25 mL of purified water and mixed thoroughly until all solid dissolves. Similarly, 190 ul of ethylene diamine solution was added to 25 mL of purified water. The solutions were combined and stirred overnight at room temperature. By CE, this solution contains approx. 30% monomer and the pH stabilized at approx pH 3.0. Both 100 mM and 10 mM solutions were prepared by dilution with de-ionised water.

Chromium Oligomer Solution (containing 10% monomer). To the above solutions (20 ml) 1.5M sodium hydroxide solution was added drop wise such that it did not exceed pH 5 and stabilised at pH 4 after 12 hrs. By CE, this pH modified solution contains less than 10% monomer Both 100 mM and 10 mM solutions were prepared by dilution with de-ionised water.

b. Addition of Chromium Solutions to Magnetic Beads (Ademtech).

Ademtech carboxyl-terminated magnetic beads (Cat. No. 0215) were supplied from Ademtech, Fra. To prepare the beads, allow them to reach room temperature and vortex the beads for 30 sec to resuspend the beads. Remove 200 ul of stock suspension (10 mg microspheres) to a 1.5-ml microcentrifuge tube. Place the tube onto a magnetic separator for at least 60 sec, and taking care not to disturb the microsphere pellet, remove and discard the Ademtech MasterBeads solution. Remove the tube from the magnetic separator and resuspend the microspheres in 1.0 ml of deionised water. Resuspend the microspheres by vortexing for 30 sec, and divide into 4×250 ul in individual tubes. Place the tubes onto a magnetic separator for at least 60 sec to allow complete separation of microspheres from the wash solution. Taking care not to disturb the microsphere pellet, remove and discard the wash solution.

Resuspend the microspheres in 4×250 ul of the various chromium solutions. Resuspend the microspheres by vortexing for 30 sec. Incubate the microspheres in the chromium oligomer solutions for 60 minutes at room temperature using end-over-end rotation in a tube rotator to keep the microspheres in suspension. The beads can be stored in the same solution at 4° C.

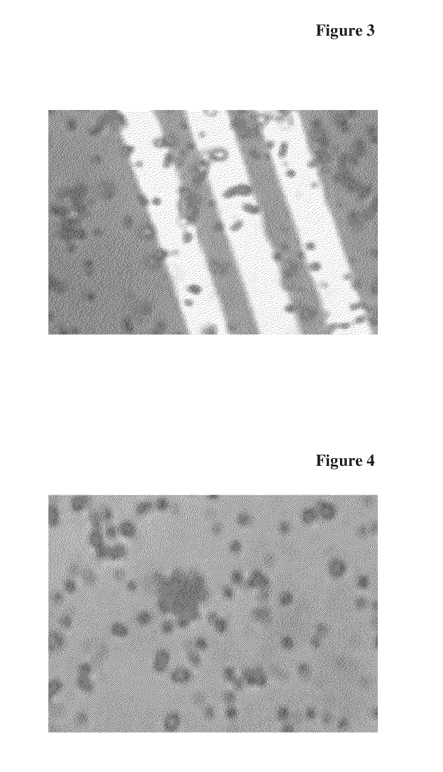

Microscopy pictures of the beads treated by the different oligomer solutions are shown in FIGS. 3 to 6.

c. Coupling of Goat Anti-Mouse Polyclonal Antibody to Chromium Ligated Bead Surface

Take the chromium activated Ademtech beads from the rotor and vortex suspension for 30 secs. Place the tubes on the magnetic separator for at least 60 sec to allow complete separation of chromium, activated Ademtech beads from the solution. Taking care not to disturb the microsphere pellet, remove and discard the solution. Remove the tubes from the magnetic separator and resuspend the microspheres in 250 ul of deionised water containing 0.01% Tween 20 for 30 sec. Place the tube on the magnetic separator for at least 60 sec to allow complete separation of beads from the solution. Remove the tubes from the magnetic separator. Repeat wash procedure one more time.

Prepare 1.0 mL of GAM antibody solution at 1 mg/mL in deionised water containing 0.01% Tween 20. Add 250 ul of GAM antibody solution (containing 250 ug of GAM antibody) to the various chromium activated Ademtech beads pellets. Resuspend the microspheres by vortexing for 20 sec. Incubate the microspheres for 60 minutes at room temperature using end-over-end rotation on a tube rotator. Place the tubes containing the microspheres onto the magnetic separator for at least 60 sec to allow complete separation of microspheres from the GAM antibody solution. Taking care not to disturb the microsphere pellet, remove and discard the GAM antibody solution. Remove the tubes from the magnetic separator and resuspend the microspheres in 250 ul of 50 mM TBS pH 8 containing 0.05% Tween 20, 0.3% PF-127 and 0.025% Proclin (Storage Solution). Vortex for 30 sec. Place the tube onto the magnetic separator for at least 60 sec to allow complete separation of microspheres from solution. Taking care not to disturb the microsphere pellet, remove and discard the solution. Remove the tubes from the magnetic separator. Repeat wash procedure one more time. Add 250 ul of Storage Solution to the GAM antibody-coupled microspheres. Resuspend GAM antibody-coupled beads at 10 mg/mL by vortexing for 30 sec. Store the GAM antibody-coupled Ademtech beads at 4° C.

d. Performing Antibody Loading Assay.

The antibody loading assay on magnetic beads was performed according to the procedure below. In brief, the materials and methods are as described.

Assay Components:
Antibody coupled beads

Detection Antibody: Mouse Anti-Rabbit IgG-HRP (0.8 mgs/ml, Jackson, USA)
Wash Buffer: 10 mM PBS, pH 7.4 containing 0.05% Tween 20
Assay Buffer: 10 mM PBS, pH 7.4 containing 1% BSA, 0.05% Tween 20
Microplate: 96-well polypropylene white plate—U-shape (BioScience, Germany
Adem-Mag 96 plate magnet (Ademtech, France)
PS-alto—Substrate (Lumigen, USA)

Assay Protocols:

Dilute 10 ul of each bead sample in 90 ul of Assay Buffer. After vortexing for at least 30 secs, remove 50 ul of suspension and dilute again in 950 ul of Assay Buffer. Dilute mouse anti-rabbit IgG-HRP detection antibodies in Assay Buffer to working concentration of 1.56 ng/ml. After vortexing diluted bead suspension for at least 30 secs, add 50 ul of antibody coated beads to the wells. Remove the beads solution from wells after leaving the plate on the plate magnet for 5 mins. After adding 50 ul of detection antibodies to the appropriate wells, incubate for 60 mins at room temperature on the plate shaker in the dark. Remove the detection antibody solution from wells using the plate magnet. Add 200 ul of wash buffer to each well of the plate and place the plate on the plate shaker for 30 seconds. Remove 200 ul of supernatant from the wells. Repeat this wash another time Adding 100 ul of PS-alto to each well Read beads on FLUOstar using Luminescence method: (BMG LABTECH, Germany).

e. Example of Results.

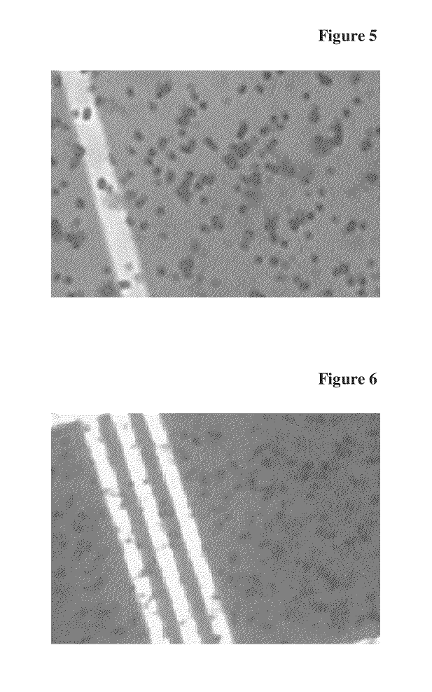

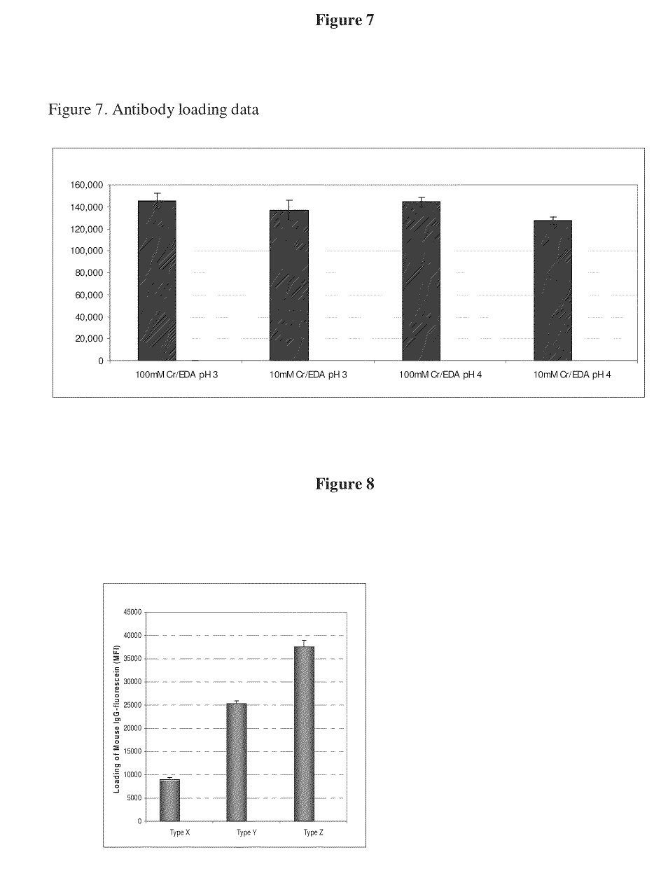

The different oligomeric compositions give different characteristics to the substrate. Both 10 and 100 mM chromium perchlorate/ethylenediamine complex at pH 3 resulted in bead aggregation with disappearance of Brownian motion (see FIGS. 3 and 4). Similarly, the 100 mM chromium perchlorate/ethylenediamine complex at pH 4 also resulted in bead aggregation with disappearance of Brownian motion (see FIG. 5). However, the 10 mM concentration at pH 4 (formulation containing approximately 10% monomer by CE) showed no observable aggregation and maintained full Brownian motion comparable to the un-modified beads. (see FIG. 6). In these examples, there was no difference in the binding capacities of goat anti-mouse (GAM) polyclonal antibody to capture mouse anti-rabbit antibody-HRP (see FIG. 7), indicating that the pH adjustment to pH4 did not detrimentally impact on the GAM coupling reaction.

### Example 4

### Increasing Oligomer Formation: Increasing Amine Ligand Concentration

While keeping to one specific chromium salt and ligand, the affect of different ligand concentrations which may subsequently affect binding of target molecules to the chromium oligomer—surface was assessed. The influence of different ethylenediamine concentrations was exemplified by testing chromium perchlorate—ethylenediamine with another magnetic bead. Antibody binding can differ according to ligand concentration as determined by loading assay.

a. Preparation of Chromium Perchlorate—Ethylenediamine Solutions.

Dissolve chromium perchlorate hexahydrate (3×1.15 g) into 3×25 mL of purified water and shake vial thoroughly until all solid dissolves. Add 67, 134 and 167.5 of ethylene diamine solution to the three chromium solutions. A precipitate will form upon addition. Shake the resulting solution on a platform mixer for 48 hrs. No precipitate should be visible. Any residual precipitate should be removed by centrifuging the solution and retaining the supernatant.

By CE analysis, the three different samples, designated X, Y and Z contain 30%, 10% and 0% monomeric components, respectively, in the oligomeric complex. The relevant pH points are 2.7, 3.0 and 3.3.

b. Addition of Chromium Oligomers to Magnetic BEADS.

BcMag Carboxyl-Terminated Magnetic beads (Cat. No. FB-101) supplied from Bioclone, CA, USA. To prepare the beads, allow them to reach room temperature and vortex the beads for 30 sec, then sonicate for another 60 sec. The beads must be suspended as single mono-dispersed particles. If any aggregate beads are observed, repeat the vortexing and sonication until aggregates are not observed. Dispense 50 uL of bead concentrate into a 1.7 mL microtube. Place all tubes on a magnetic rack for 1 min and carefully remove and discard the supernatant from the bead pellet. To the bead pellet, add 50 uL of different chromium solutions (designated Type X, Y and Z, respectively) and vortex tubes for 30 secs, and then stand the suspension for 60 min with occasional mixing.

c. Coupling of Goat Anti-Mouse Polyclonal Antibody to Chromium Ligated Bead Surface

Take the chromium activated BcMag beads from the rotor and vortex suspension for 30 secs. Aliquot 12.5 ul of each type of activated beads into another tube. Place tube on a magnetic rack for 1 min and carefully remove and discard the supernatant from the bead pellet. To the bead pellet, add 50 uL of 50 mM MES buffer to the tube. Vortex, and repeat the mES buffer wash 2 more times. After removing supernatant, add 50 ul of 500 ug/ml goat anti-mouse polyclonal antibody, Fc specific (Lampire Biological, USA) and vortex suspension for 30 secs, and then stand the suspension for 60 min with occasional mixing. After vortexing the suspension for 30 secs, place all tubes on a magnetic rack for 1 min and carefully remove and discard the supernatant from the bead pellet. To the bead pellet, add 50 uL of 150 mM Saline with 0.025% Proclin 300 solution to the tube. Vortex, and repeat wash in saline solution 2 more times.

d. Coupling of Mouse Monoclonal Antibody to Chromium Ligated Bead Surface

Take the chromium activated BcMag beads from the rotor and vortex suspension for 30 secs. Aliquot 12.5 ul of each type of activated beads into another tube. Place tube on a magnetic rack for 1 min and carefully remove and discard the supernatant from the bead pellet. To the bead pellet, add 50 uL of 50 mM MES buffer to the tube. Vortex, and repeat the MES buffer wash 2 more times. After removing supernatant, add 50 ul of 500 ug/ml 3Al-mouse monoclonal antibody (Agen, Australia) and vortex suspension for 30 secs, and then stand the suspension for 60 min with occasional mixing. After vortexing the suspension for 30 secs, place all tubes on a magnetic rack for 1 min and carefully remove and discard the supernatant from the bead pellet. To the bead pellet, add 50 uL of 150 mM Saline with 0.025% Proclin 300 solution to the tube. Vortex, and repeat wash in saline solution 2 more times.

e. Performing Antibody Loading Assay.

The antibody loading assay on magnetic beads was performed according to the procedure below. In brief, the materials and methods are as described.

Assay Components:
Antibody coupled beads

Detection Antibody:
Goat anti-mouse-IgG-R-Phycoerythrin (250 ug/ml, Sigma, USA).
Mouse-IgG-FITC (2 mgs/ml, Jackson, USA)
Wash Buffer: 10 mM PBS, pH 7.4 containing 0.05% Tween 20
Assay Buffer: 10 mM PBS, pH 7.4 containing 1% BSA, 0.05% Tween 20
Microplate: PP White, U Form (Greinerbio, USA)

Assay Protocols:

Dilute 2.5 ul of each bead sample in 60 ul of Assay Buffer. After vortexing, for at least 60 secs, remove 20 ul of suspension and dilute again in 480 ul of Assay Buffer. Dilute mouse IgG-FITC detection antibodies in Assay Buffer to working concentration of 20 ug/ml. Dilute goat anti-mouse IgG-RPE detection antibodies in Assay Buffer to working concentration of 1 ug/ml.

After vortexing diluted bead suspension for at least 60 secs, add 50 ul of antibody coated beads to the wells. After adding 50 ul of detection antibodies to the appropriate wells, incubate for 60 mins at room temperature in the dark. Place the bead plate on the magnetic plate for 2 mins, and remove 100 ul of supernatant from the wells. Add 100 ul of Wash Buffer to each well and place the bead plate on the magnetic plate for 2 mins, and remove 100 ul of supernatant from the wells. After adding 100 ul of Assay Buffer, read beads on FACS Canto II (BD Biosciences, USA).

f. Example of Results

As shown in FIG. 8, the binding capacity of goat anti-mouse (GAM) polyclonal antibody to capture mouse monoclonal antibody-fluorescein changes with the different chromium oligomeric mixtures (designated Type X, Y and Z, respectively) used to bind the GAM antibody to the substrate.

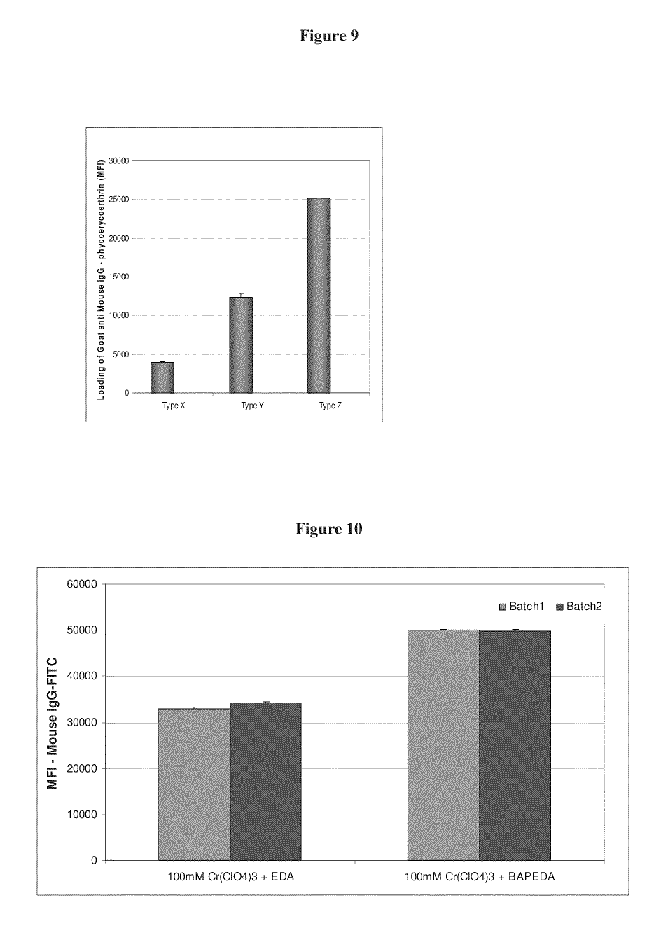

Similarly in FIG. 9, the binding capacity of mouse monoclonal antibody to capture goat anti-mouse (GAM) polyclonal antibody-phycoerythrin changes with the different chromium oligomeric mixtures (designated Type X, Y and Z, respectively) used to bind the Mouse antibody to the substrate.

### Example 5

### Increasing Oligomer Formation: Using Different Amine Ligands

a. Formation of Different Chromium Oligomers.

Chromium Perchlorate with Ethylenediamine.

In brief, chromium perchlorate hexahydrate (2.3 g) was dissolved into 25 mL of purified water and mixed thoroughly until all solid dissolves. Similarly, 190 ul of ethylene diamine solution was added to 25 mL of purified water. The solutions were combined and stirred overnight at room temperature. By CE, thus solution contains 30% monomer Chromium Perchlorate with Bis(3-aminopropyl)diethylamine. The pH was 2.3.

In brief, chromium perchlorate hexahydrate (2.3 g) was dissolved into 25 mL of purified water and mixed thoroughly until all solid dissolves. Similarly, 545 ul of bis(3-aminopropyl)diethylamine solution was added to 25 mL of purified water. The solutions were combined and stirred stirred for 2 days at room temperature. By CE, this particular solution shows no peak corresponding to the chromium monomer. The pH was 4.8.

b. Addition of Chromium Oligomers to Magnetic Beads (Bangs).

ProMag carboxyl-terminated magnetic beads (Cat. No. PMC3N/9080) were supplied from Bangs, 1N, USA. To prepare the beads, allow them to reach room temperature and vortex the beads for 30 sec, then sonicate for another 60 sec. Dispense 2×550 uL of bead concentrate into a 2×1.7 mL microtube. Place tubes on a magnetic rack for 1 min and carefully remove and discard the supernatant from the bead pellet. To the bead pellet, add to each tube 550 uL of the respective chromium oligomer solutions. Leave for 1 hr at RT with rotation.

c. Coupling of Goat Anti-Mouse Polyclonal Antibody to Chromium Ligated Bead Surface

Take the chromium oligomer activated Bangs ProMag beads from the rotor and vortex suspension for 30 secs. Place tubes on a magnetic rack for 1 min and carefully remove and discard the supernatant from the bead pellet. Add to each tube, 550 ul of 50 mM MES buffer (pH 5.2). Repeat vortexing, removal of supernatant and MES addition two (2) more times. After removal of supernatant, add 550 ul of 1 mg/ml goat anti-mouse polyclonal antibody, Fc specific (Lampire Biological, Cat. No. 7455527, USA) in 50 mM MES to the bead pellet. Vortex bead solution for 30 secs. Incubate the tubes with rotation for 1 hr at RT.

After vortexing the suspension for 30 secs, place tubes on a magnetic rack for 1 min and carefully remove and discard the supernatant from the bead pellet. To the bead pellet, add 550 uL of 150 mM Saline with 0.025% Proclin 300 solution to the tube. Vortex, and repeat wash in saline solution 2 more times.

d. Performing Antibody Loading Assay.

The antibody loading assay on magnetic beads was performed according to the procedure below. In brief, the materials and methods are as described.

Assay Components:
Antibody coupled beads.
Detection Antibody: Mouse-IgG-FITC (2 mgs/ml, Jackson, USA)
Wash Buffer: 10 mM PBS, pH 7.4 containing 0.05% Tween 20
Assay Buffer: 10 mM PBS, pH 7.4 containing 1% BSA, 0.05% Tween 20
Microplate: 96-well Millipore 0.42 um filter plate (Millipore, USA)

Assay Protocols:

Dilute 2.5 ul of each bead sample in 50 ul of Assay Buffer. After vortexing for at least 30 secs, remove 10 ul of suspension and dilute again in 490 ul of Assay Buffer. Dilute mouse IgG-FITC detection antibodies in Assay Buffer to working concentration of 10 ug/ml. After vortexing diluted bead suspension for at least 30 secs, add 50 ul of antibody coated beads to the wells. Remove the beads solution from wells using filter vaccuum apparatus. After adding 50 ul of detection antibodies to the appropriate wells, incubate for 60 mins at room temperature on the plate shaker in the dark. Remove the detection antibody solution form wells using filter vacuum apparatus. Add 200 ul of wash buffer to each well of the plate and place the plate on the plate shaker for 30 seconds. Remove 200 ul of supernatant from the wells. Adding 100 ul of Wash Buffer to each well, read beads on FACS Canto II (BD Biosciences, USA).

e. Example of Results.

As shown in FIG. 10, use of different ligands at the same molar concentration forms different oligomeric complexes and changes the binding capacity of goat anti-mouse (GAM) polyclonal antibody to capture mouse monoclonal antibody-fluorescein.

### Example 6

### Manipulating Hydrolytic Oligomer Formation of Oligomeric Metal—Substrate Complexes. Pre-Treatment of Activated Metal—Substrate Complex Using Buffers Prior to Binding Target Molecule

A formulation having approx 30% monomeric component in the metal-substrate complex was used as a model to determine the influence of changing the electron donating conditions in the complexes, and its subsequent effect on target molecule binding and its performance. The influence of different washing buffer was exemplified by comparison of MES buffer pH5.2 with MES buffer 017. Antibody binding to surface bound chromium oligomers can differ according to washing buffer pH selection as determined by loading assay.

a. Chromium Species Selection.

The chromium perchlorate with ethylenediamine complex having approx 30% monomeric component (see Example 5a) was used.

b. Addition of Washing Buffer to Magnetic Beads (Dynal).

M-270 carboxyl-terminated magnetic beads (Cat. No. 143.16D) were supplied from Dynal, Ind., Norway. To prepare the beads, allow them to reach room temperature and vortex the beads for 30 sec, then sonicate for another 60 sec. Dispense 2×140 uL of bead concentrate into 2× 1.7 mL microtube. Place tubes on a magnetic rack for 1 min and carefully remove and discard the supernatant from the bead pellet. To the bead pellet, add to 420 uL of the chromium perchlorate/ethylenediamine solution. Leave for 1 hr at RT with rotation.

Take the chromium perchlorate/ethylenediamine activated DynabeadsM-270 beads from the rotor and vortex suspension for 30 secs. Dispense 50 μl solutions into 2 tubes. Place, tubes on a magnetic rack for 1 min and carefully remove and discard the supernatant from the bead pellet. Add to each tube, 50 uL of washing buffers 50 mM MES (pH5.2) or 50 mM MES (pH7.0). Repeat vortexing, removal of supernatant and repeat MES (pH 5.2 or pH 7.0) wash two (2) more times.

c. Coupling of Goat Anti-Mouse Polyclonal Antibody to Chromium Ligated Bead Surface

After removal of supernatant, add 50 ul of 0.5 mg/ml goat anti-mouse polyclonal antibody, Fc specific (Lampire Biological, Cat. No. 7455527, USA) in 50 mM MES (pH5.2 or pH7.0) to the bead pellet. Vortex bead solution for 30 secs. Incubate the tubes with rotation for 1 hr at RT.

After vortexing the suspension for 30 secs, place tubes on a magnetic rack for 1 min and carefully remove and discard the supernatant from the bead pellet. To the bead pellet, add 50 uL of 50 mM TBS buffer (pH8.0) with 0.025% Proclin 300 to the tube. Vortex, and repeat wash in TBS buffer 2 more times.

d. Performing Antibody Loading Assay.

The antibody loading assay on magnetic beads was performed according to the procedure as previously described in Example 5d.

e. Example of Results.

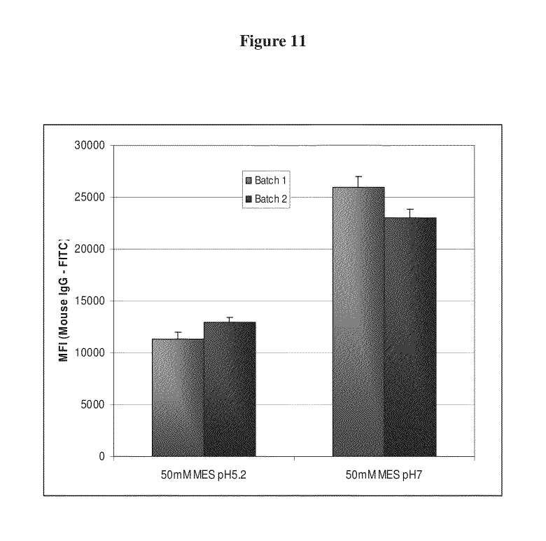

As shown in FIG. 11, post treatment of metal-substrate complexes by changing pH conditions after forming oligomeric metal-substrate complexes and prior to addition of target molecule in the form of GAM polyclonal antibody, can be used to further modify oligomeric metal compositions and subsequently changes binding and performance of target molecule.

### Example 7

### Influence of Different Surfaces and Materials on Forming Optimum Metal Oligomer—Substrate Complexes

A formulation having approx 30% monomeric component was used as a model to show that the surface properties of the substrate can significantly change the properties of target molecule binding and its performance.

a. Chromium Species Selection.

The chromium perchlorate with ethylenediamine complex having approx 30% monomeric component (see Example 5a) was used as a model.

b. Selection of Different Surfaces on Beads.

For comparative purposes, silica beads having hydroxyl and carboxy functionalities were compared to a polymeric bead.

ProMag-COOH (Cat. No. PMC3N/9885) from Bangs, Ind., USA

Silica-OH (Cat No. SS06N) from Bangs, 1N, USA.

Silica-COOH (Cat No. SC05H) from Bangs, 1N, USA

c. Addition of Chromium Perchlorate/Ethylenediamine to Magnetic Beads.

All beads were treated in a similar manner as described in Example 5b.

Take the chromium oligomer activated beads (250 ul) from the rotor and vortex suspension for 30 secs. Place tubes on a magnetic rack for 1 min and carefully remove and discard the supernatant from the bead pellet. Add to each tube, 250 ul of 50 mM MES buffer (pH 5.2). Repeat vortexing, removal of supernatant and MES addition two (2) more times.

d. Coupling of Goat Anti-Mouse Polyclonal Antibody to Different Chromium Ligated Bead Surfaces

After removal of supernatant, add 250 ul of 1 mg/ml goat anti-mouse polyclonal antibody, Fc specific (Lampire Biological, Cat. No. 7455527, USA) in 50 mM MES to the bead pellet. Vortex bead solution for 30 secs. Incubate the tubes with rotation for 1 hr at RT.

After vortexing the suspension for 30 secs, place tubes on a magnetic rack for 1 mM and carefully remove and discard the supernatant from the bead pellet. To the bead pellet, add 250 uL of 150 mM Saline with 0.025% Proclin 300 solution to the tube. Vortex, and repeat wash in saline solution 2 more times.

e. Performing Antibody Loading Assay.

The antibody loading assay on magnetic beads was performed according to the procedure as previously described in Example 5d.

f. Coupling of Streptavidin to Different Chromium Ligated Bead Surfaces

Take the chromium oligomer activated beads (250 ul) from the rotor and vortex suspension for 30 secs (see Example 6b). Place tubes (for magnetic beads) on a magnetic rack for 1 min or place tubes (for non-magnetic beads) in Micro-centrifuge for 3 minutes at 12,000 SPR, and carefully remove and discard the supernatant from the bead pellet. Add to each tube, 250 ul of 50 mM MES buffer (pH 5.2). Repeat vortexing, removal of supernatant and MES addition two (2) more times. After removal of supernatant, add 250 ul of 0.5 mg/ml streptavidin (Prozyme, Cat. No. SA10, USA) in 50 mM MES to the bead pellet. Vortex bead solution for 30 secs. Incubate the tubes with rotation for 1 hr at RT.

After vortexing the suspension for 30 secs, place tubes on a magnetic rack for 1 min or in Micro-centrifuge for 3 minutes at 12,000 SPR, and carefully remove and discard the supernatant from the bead pellet. To the bead pellet, add 250 uL of 150 mM Saline with 0.025% Proclin 300 solution to the tube. Vortex, and repeat wash in saline solution 2 more times.

g. Performing Biotin-RPE Loading Assay.

The Biotin-Phycoerythrin (Biotin-RPE) loading assay on the streptavidin coupled beads was performed according to the procedure below. In brief, the materials and methods are as described.

Assay Components:

Streptavidin coupled beads.

Detection: Biotin-PE (4 mgs/ml, Cat No. P811, Invitrogen, USA)

Wash Buffer: 10 mM PBS, pH 7.4 containing 0.05% Tween 20

Assay Buffer: 10 mM PBS, pH 7.4 containing 1% BSA, 0.05% Tween 20
Microplate: 96-well Millipore 0.42 um filter plate (Millipore, USA)

Assay Protocols:

Dilute 5 ul of each bead sample in 25 ul of Assay Buffer. After vortexing for at least 30 secs, remove 20 ul of suspension and dilute again in 480 ul of Assay Buffer. Dilute detection Biotin-RPE in Assay Buffer to working concentration of 0.4 ug/ml.

After vortexing diluted bead suspension for at least 30 secs, add 100° ul of streptavidin coated beads to the wells. Remove the beads solution from wells using filter vaccuum apparatus. After adding 50 ul of detection Biotin-RPE to the appropriate wells, incubate for 60 mins at room temperature on the plate shaker in the dark. Remove the detection Biotin-RPE solution form wells using filter vaccuume apparatus. Add 200 ul of wash buffer to each well of the plate and place the plate on the plate shaker for 30 seconds. Remove 200 ul of supernatant from the wells. Adding 100 ul of Wash Buffer to each well, read beads on FACS Canto II (BD Biosciences, USA).

h. Example of Results.

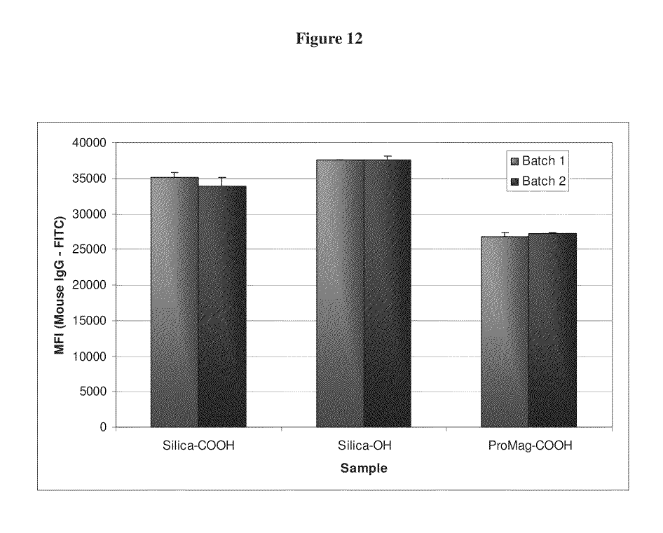

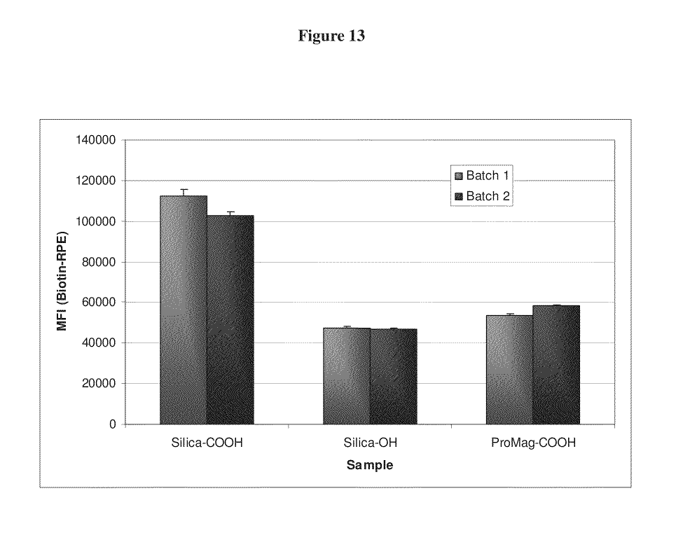

As shown in FIG. 12, oligomeric metal complexes are effective in binding antibodies on silica surfaces whether the surface has either —OH or —COOH functionalities. The example shows comparable performance with polymeric beads using one particular formulation of oligomeric metal complexes. The same oligomeric metal-substrate complexes are also effective in binding streptavidin but the profile of performance improvement is both substrate and oligomeric metal complex dependent (see FIG. 13).

### Example 8

### Manipulating Hydrolytic Oligomer Formation of Oligomeric Metal-Substrate Complexes in Combination with Target Molecule Binding

A formulation having approx 30% monomeric component to form a metal-substrate complex was used as a model to determine the influence of changing the electron donating conditions in the complexes. In Example 8, the influence of target molecule coupling conditions is exemplified by comparing pH and ionic strength differences.

a. Chromium Species Selection.

The chromium perchlorate with ethylenediamine complex having approx 30% monomeric component (see Example 5a) was used.

b. Addition of Chromium Oligomers to Magnetic Beads (Dynal).

M-270 carboxyl-terminated magnetic beads (Cat. No. 143.16D) were supplied from Dynal, Ind., Norway. To prepare the beads, allow them to reach room temperature and vortex the beads for 30 sec, then sonicate for another 60 sec. Dispense 2×170 uL of bead concentrate into 2× 1.7 mL microtube. Place tubes on a magnetic rack for 1 min and carefully remove and discard the supernatant from the bead pellet. To the bead pellet, add to 510 uL of the respective chromium oligomer solutions. Leave for 1 hr at RT with rotation.

Take the chromium oligomer activated DynabeadsM-270 beads from the rotor and vortex suspension for 30 secs. Dispense 50 μl solutions into 5 tubes. Place tubes on a magnetic rack for 1 min and carefully remove and discard the supernatant from the bead pellet Add to each tube, 50 uL of different coupling buffer 25 mM MES (pH 6.5), 50 mM MES (pH6.0, 6.5 and pH7.0) and 100 mM MES (pH 6.5). Repeat vortexing, removal of supernatant and use same MES wash conditions two (2) more times.

c. Coupling of Goat Anti-Mouse Polyclonal Antibody to Chromium Ligated Bead Surface using Different Coupling Buffer pH

After removal of supernatant, add 50 ul of 0.5 mg/ml goat anti-mouse polyclonal antibody, Fc specific (Lampire Biological, Cat. No. 7455527, USA) in the same respective MES buffers to the bead pellet. Vortex bead solution for 30 secs. Incubate the tubes with rotation for 1 hr at RT.

After vortexing the suspension for 30 secs, place tubes on a magnetic rack for 1 min and carefully remove and discard the supernatant from the bead pellet. To the bead pellet, add 50 uL of 50 mM TBS buffer (pH8.0) with 0.025% Proclin 300 to the tube. Vortex, and repeat wash in TBS 2 more times.

d. Performing Antibody Loading Assay.

The antibody loading assay on magnetic beads was performed according to the procedure as previously described in Example 5d.

e. Example of Results.

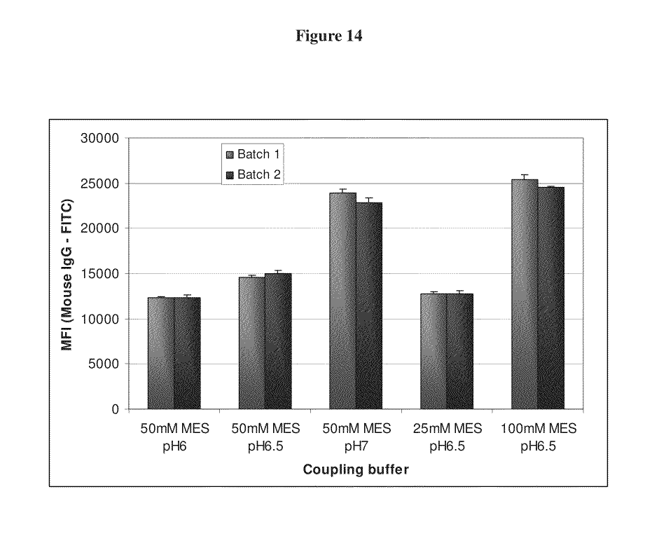

As shown in FIG. 14, use of different coupling buffer to oligomeric metal bead complexes changes the binding capacity of goat anti-mouse (GAM) polyclonal antibody to capture mouse monoclonal antibody-fluorescein.

### Example 9

### Manipulating Hydrolytic Oligomer Formation of Oligomeric Metal-Substrate Complexes. Forming a Stable but Active Metal—Substrate Complexes

A formulation having approx 30% monomeric component to form a metal-substrate complex was used as a model to determine the influence of changing the electron donating conditions in the complexes, and its subsequent effect on long term storage of oligomeric metal-substrate complexes depending on storage conditions. The influence of different washing buffer was exemplified by comparison of dH2O, MES buffer pH5.2 and MES buffer pH7. Antibody binding to surface bound chromium oligomers can differ according to the storage conditions as determined by loading assay.

a. Chromium Species Selection.

The chromium perchlorate with ethylenediamine complex having approx 30% monomeric component (see Example 5a) was used.

b. Addition of Chromium Oligomers to Silica-COOH beads (Bangs).

Silica carboxyl-terminated beads (Inv. L080722G) were supplied from Bangs, 1N, USA. To prepare the beads, allow them to reach room temperature and vortex the beads for 30 sec, then sonicate for another 60 sec. Dispense 2×600 uL of bead concentrate into 2× 1.7 mL microtube. Place all tubes in Micro-centrifuge for 5 minutes at 2000 rpm and carefully remove and discard the supernatant from the bead pellet. To the bead pellet, add to 600 uL of chromium oligomer solution. Leave for 1 hr at RT with rotation. Split chromium oligomer activated Silica beads to three tubes. In Tube 1, the beads were washed with 200 uL of dH2O with 0.025% ProClin 300 and repeated two (2) more times. The chromium oligomer activated Silica beads were store in 200 ul of dH2O with 0.025% ProClin 300. In Tube 2, the beads were washed with 200 uL of 50 mM MES 0-15.2 with 0.025% ProClin 300 and repeated two (2) more times. The chromium oligomer activated Silica beads store in 200 ul of 50 mM MES pH5.2 with 0.025% ProClin 300. In Tube 3, the beads were washed with 200 uL of 10 mM PBS pH7.4 with 0.025% ProClin 300 and repeated two (2) more times. The chromium oligomer activated Silica beads store in 200 ul of 10 mM PBS pH7.4 with 0.025% ProClin 300.

The different chromium activated Bangs Silica COOH beads were stored for different times (0 day, 7 days, 30 days and 180 days) and tested for binding of antibody.

c. Coupling of Goat Anti-Mouse Polyclonal Antibody to Chromium Ligated Bead Surface

Take the chromium oligomer activated DynabeadsM-270 beads from the rotor and vortex suspension for 30 secs. Place all tubes in Micro-centrifuge for 5 minutes at 2000 rpm and carefully remove and discard the supernatant from the bead pellet. Add to each tube, 50 uL of 50 mM MES (pH5.2). Repeat vortexing, removal of supernatant and MES addition two (2) more times. After removal of supernatant, add 50 ul of 1 mg/ml goat anti-mouse polyclonal antibody, Fc specific (Lampire Biological, Cat. No. 7455527, USA) in 50 mM MES (pH5.2) to the bead pellet. Vortex bead solution for 30 secs. Incubate the tubes with rotation for 1 hr at RT.

After vortexing the suspension for 30 secs, place all tubes in Micro-centrifuge for 5 minutes at 2000 rpm and carefully remove and discard the supernatant from the bead pellet. To the bead pellet, add 50 uL of 150 mM Saline with 0.025% Proclin 300 solution to the tube. Vortex, and repeat wash in saline solution 2 more times.

d. Performing Antibody Loading Assay.

The antibody loading assay on magnetic beads was performed according to the procedure as previously described in Example 5d.

e. Example of Results.

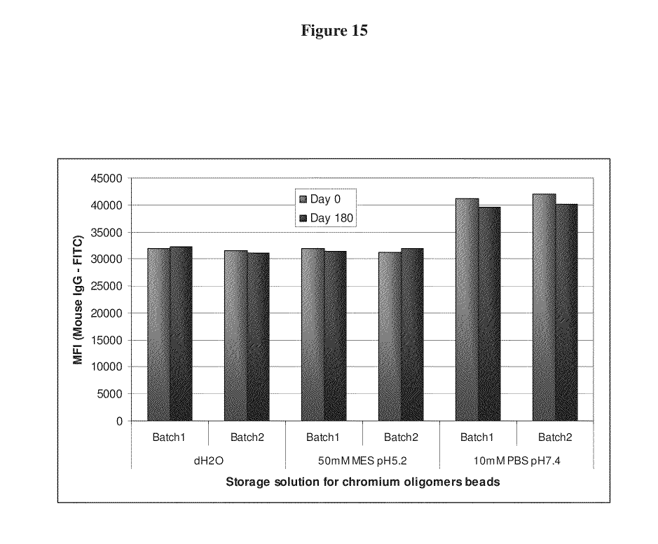

As shown in FIG. 15, activated chromium oligomer bead complexes are stable showing the same performance when goat anti-mouse (GAM) antibody was coupled immediately or after 180 day storage. Even storage in PBS which is supposed to destroy binding gives better performance of GAM to capture mouse monoclonal antibody-fluorescein.

TABLE 1
Table 1. Solutions of chromium monomer, dimer and trimer
solutions analysed by UV/Vis spectrometry.

| | Peak | Intensity | Peak | Intensity | Ratio | Trough |
|---|---|---|---|---|---|---|
| Monomer Sln | 575.3 | 0.1642 | 407.6 | 0.1836 | 1.118 | 478 |
| Dimer Sln | 584.1 | 0.0611 | 417.3 | 0.0608 | 0.995 | 487 |
| Trimer Sln | 581 | 0.1054 | 421.1 | 0.1666 | 1.581 | 496.1 |

TABLE 2
Table 2. TSH assays on Luminex beads coupled with anti-
TSH antibody via different chromium solutions gave
distinctly different outcomes. The chromium monomer
gave the poorest outcome compared to the oligomers.

| [TSH]/ | Solutions from Column | | |
|---|---|---|---|
| uIU/ml | Monomer | Dimer | Trimer |
| 1 | 58 | 166 | 389 |
| 0.1 | 7 | 20 | 51 |

1. A method of adapting a synthetic substrate for immobilisation of a target molecule thereon including:
providing a synthetic substrate;
providing metal ions for binding with the substrate, wherein the metal ions are not complexed with a target molecule;
contacting the metal ions with the substrate in the absence of a target molecule thereby forming a co-ordination complex in which the substrate is bound to co-ordination sites of the metal ions; and
forming oligomeric metal complexes from the metal ions in the presence of the substrate so that substantially all of the metal ions in the co-ordination complex with the substrate are in the form of oligomeric metal complexes;
thereby adapting the substrate for immobilisation of a target molecule thereon.

2. The method of claim 1 including the step of providing conditions for forming electron donating groups for bridging two or more metal ions when the metal ions are in contact with the substrate, thereby forming oligomeric metal complexes from the metal ions in the presence of substrate so that substantially all metal ions in the co-ordination complex with the substrate are in the form of oligomeric metal complexes.

3. The method of claim 2 wherein the conditions for forming electron donating groups are provided by providing a pH of about 3.3 to 11, preferably about 4 to 10, when the metal ions are in contact with the substrate.

4. A method of adapting a synthetic substrate for immobilisation of a target molecule thereon including:
providing metal ions for binding with a substrate, wherein the metal ions are not complexed with a target molecule;
forming oligomeric metal complexes from the metal ions in the absence of substrate so that substantially all of the metal ions are in the form of oligomeric metal complexes; and
contacting the oligomeric metal complexes with the substrate in the absence of a target molecule thereby forming a co-ordination complex in which the substrate is bound to co-ordination sites of the metal ions of the oligomeric metal complexes;
thereby adapting said substrate for immobilisation of a target molecule thereon.

5. The method of claim 4 wherein the metal ions are provided in the form of a composition and the step of forming oligomeric metal complexes from the metal ions in the absence of substrate includes providing conditions to the composition for forming electron donating groups for bridging two or more metal ions in the composition.

6. The method of claim 5 wherein the conditions for forming electron donating groups are provided by providing a pH of about 3.3 to 11, preferably about 4 to 10, to the composition.

7. The method of claim 3 or 6 wherein the pH conditions are provided by providing an alkaline salt.

8. The method of claim 7 wherein the alkaline salt is NaOH, KOH, or NH₄OH.

9. The method of claim 8 further including providing a bridging ligand in the form of a compound having an acidic group.

10. The method of claim 9 wherein the acidic group is a carboxylic, sulphonic, phosphoric, enolic, phenolic, thioenolic or thiophenolic group.

11. The method of claim 9 wherein the binding ligand is iminodiacetic acid, nitrilotracetic acid, oxalic acid, or salicylic acid.

12. The method of claim 3 or 6 wherein the pH conditions are provided by adding a bridging ligand in the form of a compound having a basic group.

13. The method of claim 12 wherein the basic group is an amine or imine.

14. The method of claim 12 wherein the binding ligand is pyridine, imidazole, benzimidazoe, histidine, or pyridine.

15. The method of claim 12 wherein the binding ligand is ethylenediamine.

16. The method of claim 1 or 4 wherein the metal ion is a transition metal.

17. The method of claim 16 wherein the metal is rhodium, platinum, scandium, aluminium, titanium, vanadium, chromium, ruthenium, manganese, iron, cobalt, nickel, copper, molybdenum or zinc.

18. The method of claim 17 wherein the metal is iron, cobalt, aluminium, chromium or ruthenium.

19. The method of claim 18 wherein the metal is chromium III.

20. The method of claim 1 or 4 wherein the metal ions are provided in the form of a composition that includes a bridging ligand according to claim 12.

21. The method of claim 20 wherein the composition includes chromium metal ions and ethylenediamine.

22. The method of claim 21 wherein the composition further includes a counter ion, preferably chloride, acetate, bromide, nitrate, perchlorate, phosphate, alum or sulphate.

23. The method of claim 1 or 4 wherein preferably more than 75%, preferably more than 80%, preferably more than 85%, preferably more than 90%, preferably more than 95%, preferably more than 98 or 99% of metal ions in the co-ordination complex with the substrate are in the form of oligomeric metal complexes.

24. The method of claim 1 or 4 wherein the oligomeric complexes include more than one type of metal ion.

25. The method according to claim 1 or 4 wherein the substrate is in the form of a bead, membrane, multi-well plate, slide, or capillary column.

26. The method according to claim 1 or 4 wherein the substrate is produced from silica, glass, gold or other metals, polypropylene, polyethylene, and polyvinylflouride.

27. The method of claim 24 or 25, wherein the substrate comprises hydroxylated silica surfaces, poly(vinylalcohol) surfaces or methacrylate surfaces.

28. The method of claim 1 or 4 wherein the substrate contains carboxylic acid functionalised, amide functionalised, amine functionalised, hydroxyl functionalised, aldehyde functionalised or other electron donating groups.
